(19) United States
(12) Patent Application Publication
(10) Pub. No.: US 2010/0306249 A1
(43) Pub. Date: Dec. 2, 2010

(54) SOCIAL NETWORK SYSTEMS AND METHODS

(76) Inventors: James Hill, Mission Viejo, CA (US); John Foster, Newport Coast, CA (US)

Correspondence Address: MCDERMOTT WILL & EMERY LLP, 18191 VON KARMAN AVE., SUITE 500, IRVINE, CA, 92612-7108, US

(21) Appl. No.: 12/789,388

(22) Filed: May 27, 2010

Related U.S. Application Data
(60) Provisional application No. 61/181,625, filed on May 27, 2009.

(51) Int. Cl. G06F 3/048; G06F 17/30

(52) U.S. Cl. 707/769; 715/753; 707/E17.108

(57) ABSTRACT

Embodiments of computer-implemented methods and systems are described, including: in a computer network system, providing a user page region viewable by a user; providing to the user, in the user page region, indicators of each of three categories, the categories consisting essentially of: (i) what the user has, (ii) what the user wants, and (c) what the user has thought or is thinking; wherein the user page region accepts a post by the user; after the post by the user, displaying the post in a group page region, viewable by a set of one of more persons other than the user, the set of persons being separated from the user at locations on a network; before the displaying, requiring the user to select one of the three categories to be associated with the post; and displaying the category selected by the user, with the post, in the group page region.

### FIELD OF THE INVENTION

This application claims priority benefit from U.S. Provisional Application No. 61/181,625, filed May 27, 2009, the entire contents of which are incorporated herein by reference.

### BACKGROUND

Computer networks, particularly the Internet, have made information widely and easily available. Internet search engines, for instance, index millions of web documents linked to the Internet. A user connected to the Internet can enter a simple search query to locate quickly web documents relevant to the search query.

The World Wide Web (“web”) contains a vast amount of information. Locating a desired portion of the information, however, can be challenging. This problem is compounded because the amount of information on the web and the number of new users inexperienced at web searching grow rapidly.

A search engine is a software program designed to help a user access files stored on a computer, for example on the web, by allowing the user to ask for documents meeting certain criteria (e.g., those containing a given word, a set of words, or a phrase) and retrieving files that match those criteria. Web search engines work by storing information about a large number of web pages (hereinafter also referred to as “pages” or “documents”), which they retrieve from the web. These documents are retrieved by a web crawler or spider, which is an automated web browser which follows the links it encounters in a crawled document. The contents of each successfully crawled document are indexed, thereby adding data concerning the words or terms in the document to an index database for use in responding to queries. Some search engines, also store all or part of the document itself, in addition to the index entries. When a user makes a search query having one or more terms, the search engine searches the index for documents that satisfy the query, and provides a listing of matching documents, typically including for each listed document the URL, the title of the document, and in some search engines a portion of document's text deemed relevant to the query.

Search engines attempt to return hyperlinks to web pages in which a user is interested. Generally, search engines base their determination of the user's interest on search terms (called a search query) entered by the user. The goal of the search engine is to provide links to high quality, relevant results to the user based on the search query. Typically, the search engine accomplishes this by matching the terms in the search query to a corpus of pre-stored web pages. Web pages that contain the user's search terms are “hits” and are returned to the user.

Web directories exist to help users find information in which they are interested. The directories separate web documents into different hierarchical categories based on content. The directories often differ in the categories they create and the names assigned to the categories. The directories also often differ in the web documents that are included in their particular categories.

Social networks, dating sites, and e-commerce sites often allow users to create profile pages that reveal personal information about the users. Based on matched criteria from a search query, a user may find another user, a product, or a service in a database operated by a site owner or third party.

### SUMMARY OF THE DISCLOSURE

Methods according to some aspects of the disclosure include determining categories for results identified in a list of search results, assigning scores to the categories, and presenting one or more high scoring ones of the categories as one or more category suggestions relating to the list of search results.

Some aspects of the disclosure are directed to a method of identifying documents relevant to a search query. The method includes generating an initial set of relevant documents from a corpus based on a matching of terms in a search query to the corpus. Further, the method ranks the generated set of documents to obtain a relevance score for each document and calculates a local score value for the documents in the generated set, the local score value quantifying an amount that the documents are referenced by other documents in the generated set of documents. Finally, the method refines the relevance scores for the documents in the generated set based on the local score values.

Some embodiments include a computer-implemented method, comprising: in a computer network system, providing a first user page region; providing in the first user page region an indicator of an identity of a primary user that is (i) input by the primary user, and (ii) viewable by the primary user and by a first set of persons comprising at least one person other than the primary user; wherein the primary user and the at least one person other than the primary user are separated from each other at locations on a network in the system; providing in the first user page region a first indicator, of at least one member of a first group of parameters, the first indicator determined by input by the primary user, and the members of the first group of parameters consisting of: (a) a skill of the primary user, as specified by the primary user; (b) an item possessed by the primary user, as specified by the primary user; (c) an item rented by the primary user, as specified by the primary user; (d) a service provided by the primary user, as specified by the primary user; (e) a characteristic of the primary user, as specified by the primary user; and (f) a person known and/or related to the primary user, as specified by the primary user; and providing in the first user page region a second indicator, of at least one member of a second group of parameters, the second indicator determined by input by the primary user, and the members of the second group of parameters consisting of: (a) an item the primary user desires to acquire, as specified by the primary user; (b) an item the primary user desires to rent, as specified by the primary user; (b) a specification of potential travel by the primary user; (c) a nonmonetary aspiration of the primary user, as specified by the primary user; and (d) a person and/or a characteristic of a person the primary user desires to meet or engage in a relationship, as specified by the primary user; wherein the first and second indicators are viewable by the primary user and by the first set of persons.

In some embodiments, the first user page region comprises a web page. The web page can comprise the first user page region.

Some embodiments further comprise enabling the primary user to selectably make at least one of the first and second indicators nonviewable by the first set of persons while the least one of the first and second indicators remains viewable by the primary user.

Some embodiments further comprise providing in the first user page region a third indicator, of at least another member of the first group or another member of the second group of parameters, the third indicator determined by input by the primary user. In some embodiments, the third indicator is viewable by the primary user and, based on a selection by the primary user, viewable or nonviewable by the first set of persons.

Some embodiments further comprise receiving, by a computer processor and from a client device controlled by the primary user, a search query comprising a plurality of search parameters; wherein the search parameters are based, at least in part, on at least one of: (i) the at least one member of the first group of parameters, and (ii) the at least one member of the second group of parameters; and after the receiving, providing, by the processor and to the client device, information associated with the plurality of search parameters.

Some embodiments further comprise providing at least one of the search parameters in the first user page region such that at the least one of the search parameters is viewable by the primary user and by the first set of persons.

Some embodiments further comprise providing an indicator of the information in the first user page region. Some embodiments further comprise enabling the primary user to selectably make the indicator nonviewable by the first set of persons while the indicator remains viewable by the primary user.

Some embodiments further comprise providing a secondary user page region in the computer system; providing in the secondary user page region an indicator of an identity of a secondary user that is (i) input by the secondary user, and (ii) viewable by the secondary user and by a second set of persons comprising at least one person other than the secondary user; wherein the secondary user and the at least one person other than the secondary user are separated from each other at locations on the network; providing in the secondary user page region a secondary indicator, determined by input by the secondary user and viewable by the secondary user and by the second set of persons, the secondary indicator indicating at least one of: (I) a member of an X group of parameters consisting of: (a) a skill of the secondary user, as specified by the secondary user; (b) an item possessed by the secondary user, as specified by the secondary user; (c) an item rented by the secondary user, as specified by the secondary user; (d) a service provided by the secondary user, as specified by the secondary user; (e) a characteristic of the secondary user, as specified by the secondary user; and (f) a person known and/or related to the secondary user, as specified by the secondary user; (II) a member of a Y group of parameters consisting of: (a) an item the secondary user desires to acquire, as specified by the secondary user; (b) an item the secondary user desires to rent, as specified by the secondary user; (b) a specification of potential travel by the secondary user, as specified by the secondary user; (c) a nonmonetary aspiration of the secondary user, as specified by the secondary user; and (d) a person and/or a characteristic of a person the secondary user desires to meet or engage in a relationship, as specified by the secondary user; and (III) a member of a Z group of parameters consisting of: (a) a concept the secondary user is considering, as specified by the secondary user; (b) an item and/or person about which the secondary user has learned, as specified by the secondary user; (b) a statement about a past activity and/or future activity of the secondary user and/or another person, as specified by the secondary user; and (c) a commentary and/or critique by the secondary user; wherein the information associated with the plurality of search parameters is based on an association between the secondary indicator and at least one of (i) the at least one member of the first group of parameters, and (ii) the at least one member of the second group of parameters.

In some embodiments, the secondary indicator indicates the member of the Y group of parameters, and the information associated with the plurality of search parameters is based on an association between the secondary indicator and the at least one member of the first group of parameters.

Some embodiments further comprise enabling the secondary user to purchase a good or service from the primary user by a transaction conducted over the network, the good or service indicated in the information.

In some embodiments, the secondary indicator indicates the member of the X group of parameters, and the information associated with the plurality of search parameters is based on an association between the secondary indicator and the at least one member of the second group of parameters.

Some embodiments further comprise enabling the primary user to purchase a good or service from the secondary user by a transaction conducted over the network, the good or service indicated in the information.

In some embodiments, the secondary indicator indicates the member of the Z group of parameters, and the information associated with the plurality of search parameters is based on an association between the secondary indicator and the at least one member of the first group of parameters.

In some embodiments, the secondary indicator indicates the member of the Z group of parameters, and the information associated with the plurality of search parameters is based on an association between the secondary indicator and the at least one member of the second group of parameters.

Some embodiments further comprise providing in the first user page region a third indicator, of at least one member of a third group of parameters, the third indicator determined by input by the primary user, and the third group of parameters consisting of: (a) a concept the primary user is considering, as specified by the primary user; (b) an item and/or person about which the primary user has learned, as specified by the primary user; (b) a statement about a past activity and/or future activity of the primary user and/or another person, as specified by the primary user; and (c) a commentary and/or critique by the primary user.

In some embodiments, the third indicator is viewable by the primary user and, based on a selection by the primary user, viewable or nonviewable by the first set of persons.

Some embodiments further comprise providing in the first user page region a fourth indicator, of at least another member of the first group, another member of the second group, or another member of the third group of parameters, the fourth indicator determined by input by the primary user.

In some embodiments, the fourth indicator is viewable by the primary user and, based on a selection by the primary user, viewable or nonviewable by the first set of persons.

Some embodiments further comprise: receiving, by a computer processor and from a client device controlled by the primary user, a search query comprising a plurality of search parameters; wherein the search parameters are based, at least in part, on at least one of: (i) the at least one member of the first group of parameters, (ii) the at least one member of the second group of parameters, and (iii) the at least one member of the third group of parameters; and after the receiving, providing, by the processor and to the client device, information associated with the plurality of search parameters.

Some embodiments further comprise providing an indicator of the information in the first user page region.

Some embodiments further comprise enabling the primary user to selectably make the indicator nonviewable by the first set of persons while the indicator remains viewable by the primary user.

Some embodiments further comprise providing at least one of the search parameters in the first user page region such that at the least one of the search parameters is viewable by the primary user and by the first set of persons.

Some embodiments further comprise: providing a secondary user page region in the computer system; providing in the secondary user page region an indicator of an identity of a secondary user that is (i) input by the secondary user, and (ii) viewable by the secondary user and by a second set of persons comprising at least one person other than the secondary user; wherein the secondary user and the at least one person other than the secondary user are separated from each other at locations on the network; and providing in the secondary user page region a secondary indicator, determined by input by the secondary user and viewable by the secondary user and by the second set of persons, the secondary indicator indicating at least one of: (I) a member of an X group of parameters consisting of: (a) a skill of the secondary user, as specified by the secondary user; (b) an item possessed by the secondary user, as specified by the secondary user; (c) an item rented by the secondary user, as specified by the secondary user; (d) a service provided by the secondary user, as specified by the secondary user; (e) a characteristic of the secondary user, as specified by the secondary user; and (f) a person known and/or related to the secondary user, as specified by the secondary user; (II) a member of a Y group of parameters consisting of: (a) an item the secondary user desires to acquire, as specified by the secondary user; (b) an item the secondary user desires to rent, as specified by the secondary user; (b) a specification of potential travel by the secondary user, as specified by the secondary user; (c) a nonmonetary aspiration of the secondary user, as specified by the secondary user; and (d) a person and/or a characteristic of a person the secondary user desires to meet or engage in a relationship, as specified by the secondary user; and (III) a member of a Z group of parameters consisting of: (a) a concept the secondary user is considering, as specified by the secondary user; (b) an item and/or person about which the secondary user has learned, as specified by the secondary user; (b) a statement about a past activity and/or future activity of the secondary user and/or another person, as specified by the secondary user; and (c) a commentary and/or critique by the secondary user; wherein the information associated with the plurality of search parameters is based on an association between the secondary indicator and at least one of (i) the at least one member of the first group of parameters, (ii) the at least one member of the second group of parameters, and (iii) the at least one member of the third group of parameters.

In some embodiments, the secondary indicator indicates the member of the Y group of parameters, and the information associated with the plurality of search parameters is based on an association between the secondary indicator and the at least one member of the first group of parameters.

Some embodiments further comprise enabling the secondary user to purchase a good or service from the primary user by a transaction conducted over the network, the good or service indicated in the information.

In some embodiments, the secondary indicator indicates the member of the Z group of parameters, and the information associated with the plurality of search parameters is based on an association between the secondary indicator and the at least one member of the first group of parameters.

In some embodiments, the secondary indicator indicates the member of the X group of parameters, and the information associated with the plurality of search parameters is based on an association between the secondary indicator and the at least one member of the second group of parameters.

In some embodiments, the secondary indicator indicates the member of the Z group of parameters, and the information associated with the plurality of search parameters is based on an association between the secondary indicator and the at least one member of the second group of parameters.

In some embodiments, the secondary indicator indicates the member of the X group of parameters, and the information associated with the plurality of search parameters is based on an association between the secondary indicator and the at least one member of the third group of parameters.

Some embodiments further comprise enabling the primary user to purchase a good or service from the secondary user by a transaction conducted over the network, the good or service indicated in the information.

In some embodiments, the secondary indicator indicates the member of the Y group of parameters, and the information associated with the plurality of search parameters is based on an association between the secondary indicator and the at least one member of the third group of parameters.

In some embodiments, the secondary indicator indicates the member of the Z group of parameters, and the information associated with the plurality of search parameters is based on an association between the secondary indicator and the at least one member of the third group of parameters.

Some embodiments include a computer-implemented method, comprising: in a computer network system, providing a first user page region; providing in the first user page region an indicator of an identity of a primary user that is (i) input by the primary user, and (ii) viewable by the primary user and by a first set of persons comprising at least one person other than the primary user; wherein the primary user and the at least one person other than the primary user are separated from each other at locations on a network; providing in the first user page region a first indicator, of at least one member of a first group of parameters, the first indicator determined by input by the primary user, and the members of the first group of parameters consisting of: (a) a skill of the primary user, as specified by the primary user; (b) an item possessed by the primary user, as specified by the primary user; (c) an item rented by the primary user, as specified by the primary user; (d) a service provided by the primary user, as specified by the primary user; (e) a characteristic of the primary user, as specified by the primary user; and (f) a person known and/or related to the primary user, as specified by the primary user; and providing in the first user page region a second indicator, of at least one member of a second group of parameters, the second indicator determined by input by the primary user, and the members of the second group of parameters consisting of: (a) a concept the primary user is considering, as specified by the primary user; (b) an item and/or person about which the primary user has learned, as specified by the primary user; (b) a statement about a past activity and/or future activity of the primary user and/or another person, as specified by the primary user; and (c) a commentary and/or critique by the primary user; wherein the first and second indicators are viewable by the primary user and by the first set of persons.

Some embodiments further comprise enabling the primary user to selectably make at least one of the first and second indicators nonviewable by the first set of persons while remaining viewable by the primary user.

Some embodiments further comprise providing in the first user page region a third indicator, of at least another member of the first group or another member of the second group of parameters, the third indicator determined by input by the primary user.

In some embodiments, the third indicator is viewable by the primary user and, based on a selection by the primary user, viewable or nonviewable by the first set of persons.

Some embodiments further comprise: receiving, by a computer processor and from a client device controlled by the primary user, a search query comprising a plurality of search parameters; wherein the search parameters are based, at least in part, on at least one of: (i) the at least one member of the first group of parameters, and (ii) the at least one member of the second group of parameters; and after the receiving, providing, by the processor and to the client device, information associated with the plurality of search parameters.

Some embodiments further comprise providing an indicator of the information in the first user page region.

Some embodiments further comprise enabling the primary user to selectably make the indicator nonviewable by the first set of persons while the indicator remains viewable by the primary user.

Some embodiments further comprise providing at least one of the search parameters in the first user page region such that at the least one of the search parameters is viewable by the primary user and by the first set of persons.

Some embodiments further comprise providing an indicator of the information in the first user page region.

Some embodiments further comprise enabling the primary user to selectably make the indicator nonviewable by the first set of persons while the indicator remains viewable by the primary user.

Some embodiments further comprise: providing a secondary user page region in the computer system; providing in the secondary user page region an indicator of an identity of a secondary user that is (i) input by the secondary user, and (ii) viewable by the secondary user and by a second set of persons comprising at least one person other than the secondary user; wherein the secondary user and the at least one person other than the secondary user are separated from each other at locations on the network; and providing in the secondary user page region a secondary indicator, determined by input by the secondary user and viewable by the secondary user and by the second set of persons, the secondary indicator indicating at least one of: (I) a member of an X group of parameters consisting of: (a) a skill of the secondary user, as specified by the secondary user; (b) an item possessed by the secondary user, as specified by the secondary user; (c) an item rented by the secondary user, as specified by the secondary user; (d) a service provided by the secondary user, as specified by the secondary user; (e) a characteristic of the secondary user, as specified by the secondary user; and (f) a person known and/or related to the secondary user, as specified by the secondary user; (II) a member of a Y group of parameters consisting of: (a) an item the secondary user desires to acquire, as specified by the secondary user; (b) an item the secondary user desires to rent, as specified by the secondary user; (b) a specification of potential travel by the secondary user, as specified by the secondary user; (c) a nonmonetary aspiration of the secondary user, as specified by the secondary user; and (d) a person and/or a characteristic of a person the secondary user desires to meet or engage in a relationship, as specified by the secondary user; and (III) a member of a Z group of parameters consisting of: (a) a concept the secondary user is considering, as specified by the secondary user; (b) an item and/or person about which the secondary user has learned, as specified by the secondary user; (b) a statement about a past activity and/or future activity of the secondary user and/or another person, as specified by the secondary user; and (c) a commentary and/or critique by the secondary user; wherein the information associated with the plurality of search parameters is based on an association between the secondary indicator and at least one of (i) the at least one member of the first group of parameters, and (ii) the at least one member of the second group of parameters.

Some embodiments include a computer-implemented method, comprising: in a computer network system, providing a first user page region; providing in the first user page region an indicator of an identity of a primary user that is (i) input by the primary user, and (ii) viewable by the primary user and by a first set of persons comprising at least one person other than the primary user; wherein the primary user and the at least one person other than the primary user are separated from each other at locations on a network in the system; providing in the first user page region a first indicator, of at least one member of a first group of parameters, the first indicator determined by input by the primary user, and the members of the first group of parameters consisting of: (a) an item the primary user desires to acquire, as specified by the primary user; (b) an item the primary user desires to rent, as specified by the primary user; (b) a specification of potential travel by the primary user; (c) a nonmonetary aspiration of the primary user, as specified by the primary user; and (d) a person and/or a characteristic of a person the primary user desires to meet or engage in a relationship, as specified by the primary user; and providing in the first user page region a second indicator, of at least one member of a second group of parameters, the second indicator determined by input by the primary user, and the members of the second group of parameters consisting of: (a) a concept the primary user is considering, as specified by the primary user; (b) an item and/or person about which the primary user has learned, as specified by the primary user; (b) a statement about a past activity and/or future activity of the primary user and/or another person, as specified by the primary user; and (c) a commentary and/or critique by the primary user; wherein the first and second indicators are viewable by the primary user and by the first set of persons.

Some embodiments further comprise enabling the primary user to selectably make at least one of the first and second indicators nonviewable by the first set of persons while remaining viewable by the primary user.

Some embodiments further comprise providing in the first user page region a third indicator, of at least another member of the first or the second group of parameters, the third indicator determined by input by the primary user.

In some embodiments, the third indicator is viewable by the primary user and, based on a selection by the primary user, viewable or nonviewable by the first set of persons.

Some embodiments further comprise: receiving, by a computer processor and from a client device controlled by the primary user, a search query comprising a plurality of search parameters; wherein the search parameters are based, at least in part, on at least one of: (i) the at least one member of the first group of parameters, and (ii) the at least one member of the second group of parameters; after the receiving, providing, by the processor and to the client device, information associated with the plurality of search parameters.

Some embodiments further comprise providing an indicator of the information in the first user page region.

Some embodiments further comprise enabling the primary user to selectably make the indicator nonviewable by the first set of persons while the indicator remains viewable by the primary user.

Some embodiments further comprise providing at least one of the search parameters in the first user page region such that at the least one of the search parameters is viewable by the user and by the first set of persons.

Some embodiments further comprise providing an indicator of the information in the first primary user page region.

Some embodiments further comprise enabling the user to selectably make the indicator nonviewable by the first set of persons while the indicator remains viewable by the primary user.

Some embodiments further comprise: providing a secondary user page region in the computer system; providing in the secondary user page region an indicator of an identity of a secondary user that is (i) input by the secondary user, and (ii) viewable by the secondary user and by a second set of persons comprising at least one person other than the secondary user; wherein the secondary user and the at least one person other than the secondary user are separated from each other at locations on the network; and providing in the secondary user page region a secondary indicator, determined by input by the secondary user and viewable by the secondary user and by the second set of persons, the secondary indicator indicating at least one of: (I) a member of an X group of parameters consisting of: (a) a skill of the secondary user, as specified by the secondary user; (b) an item possessed by the secondary user, as specified by the secondary user; (c) an item rented by the secondary user, as specified by the secondary user; (d) a service provided by the secondary user, as specified by the secondary user; (e) a characteristic of the secondary user, as specified by the secondary user; and (f) a person known and/or related to the secondary user, as specified by the secondary user; (II) a member of a Y group of parameters consisting of: (a) an item the secondary user desires to acquire, as specified by the secondary user; (b) an item the secondary user desires to rent, as specified by the secondary user; (b) a specification of potential travel by the secondary user, as specified by the secondary user; (c) a nonmonetary aspiration of the secondary user, as specified by the secondary user; and (d) a person and/or a characteristic of a person the secondary user desires to meet or engage in a relationship, as specified by the secondary user; and (III) a member of a Z group of parameters consisting of: (a) a concept the secondary user is considering, as specified by the secondary user; (b) an item and/or person about which the secondary user has learned, as specified by the secondary user; (b) a statement about a past activity and/or future activity of the secondary user and/or another person, as specified by the secondary user; and (c) a commentary and/or critique by the secondary user; wherein the information associated with the plurality of search parameters is based on an association between the secondary indicator and at least one of (i) the at least one member of the first group of parameters, and (ii) the at least one member of the second group of parameters.

Some embodiments include a computer-implemented method, comprising: in a computer network system, providing a user page region, viewable by a user; providing to the user, in the user page region, indicators of each of three categories, the categories consisting essentially of: (i) what the user has, (ii) what the user wants, and (c) what the user has thought or is thinking; wherein the user page region accepts entry of a post by the user; after entry of the post by the user, displaying the post in a group page region, the displayed post viewable by a set of one of more persons other than the user, the set of persons being separated from the user at locations on a network in the system; before the displaying, requiring the user to select one of the three categories to be associated with the post; and displaying the category selected by the user, with the post, in the group page region.

Some embodiments further comprise: before the displaying, permitting the user to select an additional one of the three categories to be associated with the post; and displaying, with the post in the group page region, the additional category selected by the user.

Some embodiments further comprise: presenting to the user, in the user page region, at least one additional category other than the three; before the displaying, permitting the user to select one or more of the at least one additional category to be associated with the post; and displaying in the group page region, with the post, the one or more of the at least one additional category, selected by the user.

In some embodiments, the post comprises an advertisement and/or a comment on another user's post displayed in the group page region.

Some embodiments include a computer-implemented method, comprising: in a computer network system, providing a first user page region; providing in the first user page region an indicator of an identity of a primary user that is (i) input by the primary user, and (ii) viewable by the primary user and by a first set of persons comprising at least one person other than the primary user; wherein the primary user and the at least one person other than the primary user are separated from each other at locations on a network in the system; and providing in the first user page region a first indicator, determined by input of the primary user, of an object the primary user has, as specified by the primary user; providing in the first user page region a second indicator, determined by input of the primary user, of an object the primary user wants, as specified by the primary user; wherein the first and second indicators are viewable by the primary user and by the first set of persons.

Some embodiments further comprise enabling the primary user to selectably make at least one of the first and second indicators nonviewable by the first set of persons while the least one of the first and second indicators remains viewable by the primary user.

Some embodiments further comprise providing in the first user page region a third indicator, of at least another: (i) object the primary user has, as specified by the primary user; or (ii) object the primary user wants, as specified by the primary user; the third indicator determined by input by the primary user.

In some embodiments, the third indicator is viewable by the primary user and, based on a selection by the primary user, viewable or nonviewable by the first set of persons.

Some embodiments further comprise: receiving, by a computer processor and from a client device controlled by the primary user, a search query comprising a plurality of search parameters; wherein the search parameters are based, at least in part, on at least one of: (i) the object the primary user has, as specified by the primary user; and (ii) the object the primary user wants, as specified by the primary user; and after the receiving, providing, by the processor and to the client device, information associated with the plurality of search parameters.

Some embodiments further comprise providing at least one of the search parameters in the first user page region such that at the least one of the search parameters is viewable by the primary user and by the first set of persons.

Some embodiments further comprise providing an indicator of the information in the first user page region.

Some embodiments further comprise providing an indicator of the information in the first user page region.

Some embodiments further comprise enabling the primary user to selectably make the indicator nonviewable by the first set of persons while the indicator remains viewable by the primary user.

Some embodiments further comprise enabling the primary user to selectably make the indicator nonviewable by the first set of persons while the indicator remains viewable by the primary user.

Some embodiments further comprise: providing a secondary user page region in the computer system; providing in the secondary user page region an indicator of an identity of a secondary user that is (i) input by the secondary user, and (ii) viewable by the secondary user and by a second set of persons comprising at least one person other than the secondary user; wherein the secondary user and the at least one person other than the secondary user are separated from each other at locations on the network; and providing in the secondary user page region a secondary indicator, determined by input by the secondary user and viewable by the secondary user and by the second set of persons, the secondary indicator indicating at least one of: (I) an object the secondary user has, as specified by the secondary user; (II) an object the secondary user wants, as specified by the secondary user; and (III) an object of which the secondary user has thought or is thinking, as specified by the secondary user; wherein the information associated with the plurality of search parameters is based on an association between the secondary indicator and the search parameters.

In some embodiments, the secondary indicator indicates the object the secondary user wants, as specified by the secondary user; and the information associated with the plurality of search parameters is based on an association between the secondary indicator and the object the primary user has, as specified by the primary user.

In some embodiments, the secondary indicator indicates the object the secondary user has, as specified by the secondary user; and the information associated with the plurality of search parameters is based on an association between the secondary indicator and the object the primary user wants, as specified by the primary user.

In some embodiments, the secondary indicator indicates the object of which the secondary user has thought or is thinking, as specified by the secondary user; and the information associated with the plurality of search parameters is based on an association between the secondary indicator and the object the primary user wants, as specified by the primary user.

In some embodiments, the secondary indicator indicates the object of which the secondary user has thought or is thinking, as specified by the secondary user; and the information associated with the plurality of search parameters is based on an association between the secondary indicator and the object the primary user wants, as specified by the primary user.

Some embodiments further comprise providing in the first user page region a third indicator, determined by input of the primary user, of an object of which the primary user is thinking or has thought, as specified by the primary user.

In some embodiments, the third indicator is viewable by the primary user and, based on a selection by the primary user, viewable or nonviewable by the first set of persons.

Some embodiments further comprise providing in the first user page region a fourth indicator, of at least one of: (i) another object the primary user has, as specified by the primary user; (ii) another object the primary user wants, as specified by the primary user; and (iii) another object of which the primary user is thinking or has thought, as specified by the primary user.

In some embodiments, the fourth indicator is viewable by the primary user and, based on a selection by the primary user, viewable or nonviewable by the first set of persons.

Some embodiments further comprise: receiving, by a computer processor and from a client device controlled by the primary user, a search query comprising a plurality of search parameters; wherein the search parameters are based, at least in part, on at least one of: (i) the object the primary user has, as specified by the primary user; (ii) the object the primary user wants, as specified by the primary user; and (iii) the object of which the primary user is thinking or has thought, as specified by the primary user; and after the receiving, providing, by the processor and to the client device, information associated with the plurality of search parameters.

Some embodiments further comprise providing an indicator of the information in the first user page region.

Some embodiments further comprise enabling the primary user to selectably make the indicator nonviewable by the first set of persons while the indicator remains viewable by the primary user.

Some embodiments further comprise providing at least one of the search parameters in the first user page region such that at the least one of the search parameters is viewable by the primary user and by the first set of persons.

Some embodiments further comprise providing an indicator of the information in the first user page region.

Some embodiments further comprise enabling the primary user to selectably make the indicator nonviewable by the first set of persons while the indicator remains viewable by the primary user.

Some embodiments further comprise: providing a secondary user page region in the computer system; providing in the secondary user page region an indicator of an identity of a secondary user that is (i) input by the secondary user, and (ii) viewable by the secondary user and by a second set of persons comprising at least one person other than the secondary user; wherein the secondary user and the at least one person other than the secondary user are separated from each other at locations on the network; and providing in the secondary user page region a secondary indicator, determined by input by the secondary user and viewable by the secondary user and by the second set of persons, the secondary indicator indicating at least one of: (I) an object the secondary user has, as specified by the secondary user; (II) an object the secondary user wants, as specified by the secondary user; and (III) an object of which the secondary user has thought or is thinking, as specified by the secondary user; wherein the information associated with the plurality of search parameters is based on an association between the secondary indicator and the search parameters.

In some embodiments, the secondary indicator indicates the object the secondary user wants, as specified by the secondary user; and the information associated with the plurality of search parameters is based on an association between the secondary indicator and the object the primary user has, as specified by the primary user.

In some embodiments, the secondary indicator indicates the object of which the secondary user has thought or is thinking, as specified by the secondary user; and the information associated with the plurality of search parameters is based on an association between the secondary indicator and the object the primary user has, as specified by the primary user.

In some embodiments, the secondary indicator indicates the object the secondary user has, as specified by the secondary user; and the information associated with the plurality of search parameters is based on an association between the secondary indicator and the object the primary user wants, as specified by the primary user.

In some embodiments, the secondary indicator indicates the object of which the secondary user has thought or is thinking, as specified by the secondary user; and the information associated with the plurality of search parameters is based on an association between the secondary indicator and the object the primary user wants, as specified by the primary user.

In some embodiments, the secondary indicator indicates the object the secondary user has, as specified by the secondary user; and the information associated with the plurality of search parameters is based on an association between the secondary indicator and the object of which the primary user is thinking or has thought, as specified by the primary user.

In some embodiments, the secondary indicator indicates the object the secondary user wants, as specified by the secondary user; and the information associated with the plurality of search parameters is based on an association between the secondary indicator and the object of which the primary user is thinking or has thought, as specified by the primary user.

In some embodiments, the secondary indicator indicates the object of which the secondary user has thought or is thinking, as specified by the secondary user; and the information associated with the plurality of search parameters is based on an association between the secondary indicator and the object of which the primary user is thinking or has thought, as specified by the primary user.

Some embodiments include a computer-implemented method, comprising: in a computer network system, providing a first user page region; providing in the first user page region an indicator of an identity of a primary user that is (i) input by the primary user, and (ii) viewable by the primary user and by a first set of persons comprising at least one person other than the primary user; wherein the primary user and the at least one person other than the primary user are separated from each other at locations on a network in the system; providing in the first user page region a first indicator, determined by input of the primary user, of an object the primary user has, as specified by the primary user; and providing in the first user page region a second indicator, determined by input of the primary user, of an object of which the primary user is thinking or has thought, as specified by the primary user; wherein the first and second indicators are viewable by the primary user and by the first set of persons.

Some embodiments further comprise enabling the primary user to selectably make at least one of the first and second indicators nonviewable by the first set of persons while remaining viewable by the primary user.

Some embodiments further comprise providing in the first user page region a third indicator, of at least another (i) object the primary user has, as specified by the primary user; or (ii) object of which the primary user is thinking or has thought, as specified by the primary user; the third indicator determined by input by the primary user.

In some embodiments, the third indicator is viewable by the primary user and, based on a selection by the primary user, viewable or nonviewable by the first set of persons.

Some embodiments further comprise: receiving, by a computer processor and from a client device controlled by the primary user, a search query comprising a plurality of search parameters; wherein the search parameters are based, at least in part, on at least one of: (i) the object the primary user has, as specified by the primary user; and (ii) the object of which the primary user is thinking or has thought, as specified by the primary user; after the receiving, providing, by the processor and to the client device, information associated with the plurality of search parameters.

Some embodiments further comprise providing an indicator of the information in the first user page region.

Some embodiments further comprise enabling the primary user to selectably make the indicator nonviewable by the first set of persons while the indicator remains viewable by the primary user.

Some embodiments further comprise providing at least one of the search parameters in the first user page region such that at the least one of the search parameters is viewable by the primary user and by the first set of persons.

Some embodiments further comprise providing an indicator of the information in the first user page region.

Some embodiments further comprise enabling the primary user to selectably make the indicator nonviewable by the first set of persons while the indicator remains viewable by the primary user.

Some embodiments further comprise: providing a secondary user page region in the computer system; providing in the secondary user page region an indicator of an identity of a secondary user that is (i) input by the secondary user, and (ii) viewable by the secondary user and by a second set of persons comprising at least one person other than the secondary user; wherein the secondary user and the at least one person other than the secondary user are separated from each other at locations on the network; and providing in the secondary user page region a secondary indicator, determined by input by the secondary user and viewable by the secondary user and by the second set of persons, the secondary indicator indicating at least one of: (I) something the secondary user has, as specified by the secondary user; (H) something the secondary user wants, as specified by the secondary user; and (III) something the secondary user has thought or is thinking, as specified by the secondary user; wherein the information associated with the plurality of search parameters is based on an association between the secondary indicator and the search parameters.

Some embodiments include a computer-implemented method, comprising: in a computer network system, providing a first user page region; providing in the first user page region an indicator of an identity of a primary user that is (i) input by the primary user, and (ii) viewable by the primary user and by a first set of persons comprising at least one person other than the primary user; wherein the primary user and the at least one person other than the primary user are separated from each other at locations on a network; providing in the first user page region a first indicator, determined by input of the primary user, of an object the primary user wants, as specified by the primary user; and providing in the first user page region a second indicator, determined by input of the primary user, of an object of which the primary user is thinking or has thought, as specified by the primary user; wherein the first and second indicators are viewable by the primary user and by the first set of persons.

Some embodiments further comprise enabling the primary user to selectably make at least one of the first and second indicators nonviewable by the first set of persons while remaining viewable by the primary user.

Some embodiments further comprise providing in the first user page region a third indicator, of at least another (i) object the primary user wants, as specified by the primary user; or (ii) object of which the primary user is thinking or has thought, as specified by the primary user; the third indicator determined by input by the primary user.

In some embodiments, the third indicator is viewable by the primary user and, based on a selection by the primary user, viewable or nonviewable by the first set of persons.

Some embodiments further comprise: receiving, by a computer processor and from a client device controlled by the primary user, a search query comprising a plurality of search parameters; wherein the search parameters are based, at least in part, on at least one of: (i) the object the primary user wants, as specified by the primary user; and (ii) the object of which the primary user is thinking or has thought, as specified by the primary user; after the receiving, providing, by the processor and to the client device, information associated with the plurality of search parameters.

Some embodiments further comprise providing an indicator of the information in the first user page region.

Some embodiments further comprise enabling the primary user to selectably make the indicator nonviewable by the first set of persons while the indicator remains viewable by the primary user.

Some embodiments further comprise providing at least one of the search parameters in the first user page region such that at the least one of the search parameters is viewable by the user and by the first set of persons.

Some embodiments further comprise providing an indicator of the information in the first primary user page region.

Some embodiments further comprise enabling the user to selectably make the indicator nonviewable by the first set of persons while the indicator remains viewable by the primary user.

Some embodiments further comprise: providing a secondary user page region in the computer system; providing in the secondary user page region an indicator of an identity of a secondary user that is (i) input by the secondary user, and (ii) viewable by the secondary user and by a second set of persons comprising at least one person other than the secondary user; wherein the secondary user and the at least one person other than the secondary user are separated from each other at locations on the network; and providing in the secondary user page region a secondary indicator, determined by input by the secondary user and viewable by the secondary user and by the second set of persons, the secondary indicator indicating at least one of: (I) something the secondary user has, as specified by the secondary user; (II) something the secondary user wants, as specified by the secondary user; and (III) something the secondary user has thought or is thinking, as specified by the secondary user; wherein the information associated with the plurality of search parameters is based on an association between the secondary indicator and the search parameters.

Some embodiments include a computer-implemented search method, comprising: providing a first user page region that displays an indicator of an identity of a user and is viewable by the user and by a first set of persons, the first set comprising at least one person other than the user, the first set of persons and the user being separated from each other at locations on a network; receiving, by a processor of a computer and from a client device controlled by the user, a search query comprising a plurality of search parameters; after the receiving, displaying at least one of the search parameters in the first user page region such that at the least one of the search parameters is viewable by the user and by the first set of persons; after the receiving, cloaking at least one other of the search parameters, such that the at least one other of the search parameters is not viewable in the first user page region by the first set of persons; after the receiving, displaying the at least one other of the search parameters in a second user page region that is viewable by the user and not viewable by the first set of persons; and providing, by the processor and to the client device, information associated with: (i) the at least one of the search parameters displayed in the first user page region, and (ii) the at least one other of the search parameters not viewable in the first user page region by the first set of persons.

In some embodiments, the computer is at a separate location from the client device on the network. In some embodiments, the computer comprises a server in communication with the client device on the network.

In some embodiments, the at least one other of the search parameters comprises a group of one or more words, a tag, a category of items, and a specification to include or exclude one or more items.

In some embodiments, the at least one other of the search parameters is viewable in the first user page region by the user. In some embodiments, the first user page region comprises a user profile page.

Some embodiments include a computer-implemented search method, comprising: receiving, by a processor of a computer and from a first client device controlled by a first user, a first search query, a first portion of which is designated by the first user as hidden status; receiving, by a processor and from a second client device controlled by a second user, a second search query, a first portion of which is designated by the second user as non-hidden status; determining an existence of an association between the hidden first portion of the first query and the non-hidden first portion of the second query; providing, to the first user, information concerning the existence of the association; and after the determining and before further information is received from the first user, refraining from providing, to the second user, the information concerning the existence of the association.

In some embodiments, the further information received from the first user comprises permission to provide, to the second user, information concerning the existence of the association.

Some embodiments further comprise: receiving the further information from the first user; and providing, to the second user, the information concerning the existence of the association.

In some embodiments, the further information received from the first user comprises permission to provide, to the second user, information concerning the existence of the association

In some embodiments, the first portion of the first search query comprises the entire first search query. In some embodiments, the first portion of the second search query comprises the entire second search query.

Some embodiments include a computer-implemented search method, comprising: receiving, by a processor of a computer and from a first client device controlled by a first user, a first search query, a first portion of which is designated by the first user as having a hidden status; receiving, by the processor and from a second client device controlled by a second user, a second search query, a first portion of which is designated by the second user as having a non-hidden status; determining a first association between the hidden first portion of the first query and the non-hidden first portion of the second query; providing, to the first user, information concerning the first association; and after the determining and before further information is received from the first user, refraining from providing, to the second user, the information ‘concerning the first association.

In some embodiments, the further information received from the first user comprises permission to provide, to at least the second user, information concerning the first association.

Some embodiments further comprise: receiving the further information from the first user; and providing, to the second user, the information concerning the first association.

In some embodiments, the further information received from the first user comprises permission to provide, to at least the second user, information concerning the first association. In some embodiments, the information concerning the first association comprises information confirming an existence of the first association.

Some embodiments further specify that the first search query further comprises a second portion, designated by the first user as non-hidden status; and the second search query further comprises a second portion, designated by the second user as non-hidden status; and the embodiments further comprise: determining a second association between the non-hidden second portion of the first search query and the non-hidden second portion of the second search query; providing, to the first user, information concerning the second association; and before further information is received from the first user, refraining from providing, to the second user, the information concerning the second association.

In some embodiments, the further information received from the first user comprises permission to provide, to at least the second user, information concerning at least one of the first and second associations.

Some embodiments further comprise: receiving the further information from the first user; and providing, to the second user, the information concerning the second association.

In some embodiments, the further information received from the first user comprises permission to provide, to at least the second user, information concerning at least one of the first and second associations.

Some embodiments include a computer-implemented search method, comprising: receiving, by a processor of a computer and from a first client device controlled by a first user, a first search query, a portion of which is designated by the first user as hidden status; receiving, by the processor and from a second client device controlled by a second user, a second search query, a portion of which is designated by the second user as hidden status; determining an association between the hidden portion of the first search query and the hidden portion of the second search query; and after the determining, and before a first permission is received from the first user and a second permission is received from the second user, providing neither the first user nor the second user a first item of information concerning the association.

Some embodiments further comprise: providing neither the first user nor the second user the first item of information concerning the association, regardless whether the first permission is obtained from the first user and regardless whether the second permission is obtained from the second user; wherein the first item of information comprises information confirming an existence of the association.

Some embodiments further comprise: providing neither the first user nor the second user the first item of information concerning the association, regardless whether the first permission is obtained from the first user and regardless whether the second permission is obtained from the second user; wherein the first item of information comprises an indicator of an identity of at least one of the first and second users.

Some embodiments further comprise: receiving the first permission and the second permission; and thereafter, providing the first item of information to either or both of the first user and the second user.

Some embodiments further comprise: receiving the first permission and the second permission; and thereafter, providing the first item of information to both of the first user and the second user.

In some embodiments, the first item of information comprises information concerning an existence of the association.

In some embodiments, the first item of information comprises an indicator of an identity of at least one of the first and second users.

In some embodiments, the first item of information comprises information concerning an existence of the association.

In some embodiments, the first item of information comprises an indicator of an identity of at least one of the first and second users.

Some embodiments further comprise: after the determining, and before a first permission is received from the first user and a second permission is received from the second user, providing a second item of information concerning the association to at least one of the first and the second users, the second item comprising an indicator of at least one of a location and a characteristic of at least one of the first user and the second user.

In some embodiments, the second item of information concerning the association is provided to both the first user and the second user.

In some embodiments, the second item of information comprises an indicator of location, and wherein an indicator of the first user's location is provided to the second user, and an indicator of the second user's location is provided to the first user.

In some embodiments, the second item of information provided to first user is of a type selected by the second user.

Some embodiments further comprise: after the first permission and the second permission are received, providing the first item of information to both of the first user and the second user; wherein the first item of information provided to the first user comprises an indicator of an identity of the second user, and the first item of information provided to the second user comprises an indicator of an identity of the first user.

Some embodiments include a computer-implemented method, comprising: in a computer network system, providing a user page region, viewable by a user, wherein the user page region accepts a post of a search query by the user; upon the post of the search query by the user, displaying a first portion of the search query in a group page region, the group page region and the displayed first portion being viewable by a set of one of more persons other than the user, the set of persons being separated from the user at locations on a network of the system; and upon the post of the search query by the user, hiding a second portion of the search query from the group page region, such that the second portion is not viewable by the set of persons.

Some embodiments further comprise: upon the post of the search query by the user, receiving, by a computer processor, the first and second portions of the search query; and after the receiving, providing, by the processor and to a client device, information associated with the first and the second portions of the search query.

Some embodiments further comprise displaying an indicator of the information in the user page region, such that the indicator is viewable by the user.

Some embodiments further comprise hiding the indicator of the information from the group page region, such that the indicator is not viewable by the set of persons.

### BRIEF DESCRIPTION OF THE DRAWINGS

The accompanying drawings, which are incorporated in and constitute a part of this specification, illustrate an embodiment of the invention and, together with the description, explain the invention.

FIG. 1 is a diagram of a directory of business listings.

FIG. 2 is an exemplary diagram of a network in which systems and methods herein may be implemented.

FIG. 3 is an exemplary diagram of a client or server of FIG. 2.

FIG. 4 is an exemplary diagram of a portion of the search system of FIG. 2.

FIG. 5 is a flowchart of exemplary processing for presenting category suggestions relating to a search consistent with principles of the disclosure.

FIGS. 6-9 are exemplary diagrams of a local search user interface that may be presented to a user.

FIG. 7 is a diagram illustrating an exemplary system in which concepts consistent with the present inventions may be implemented.

FIG. 8 is a flow chart illustrating methods consistent with the present inventions for ranking documents within a search engine.

FIG. 9 is a flow chart illustrating, in additional detail, methods consistent with the present inventions for ranking documents within a search engine.

FIG. 10a illustrates an embodiment of a user home page.

FIG. 10b illustrates an embodiment of a listing of “wants.”

FIG. 10c illustrates an embodiment of a user item page.

FIG. 11a illustrates an embodiment of a user profile page.

FIG. 11b illustrates an embodiment of an item profile page.

FIG. 12 is a schematic view of an embodiment of cross-searching, or matching, among users “haves,” “wants,” and “thoughts.”

### DETAILED DESCRIPTION OF THE INVENTION

The following U.S. patents and published patent applications are incorporated by reference herein, in their entireties.

Google patents

| | PAT. | |
|---|---|---|
| | NO. | |
| 1 | 7,539,657 | Building parallel hybrid spill trees to facilitate parallel nearest-neighbor matching |
| | | operations |
| 2 | 7,536,641 | Web page authoring tool for structured documents |
| 3 | 7,536,408 | Phrase-based indexing in an information retrieval system |
| 4 | 7,536,382 | Query rewriting with entity detection |
| 5 | D592,219 | Graphical user interface for display screen |
| 6 | 7,533,090 | System and method for rating electronic documents |
| 7 | 7,529,780 | Conflict management during data object synchronization between client and server |
| 8 | 7,529,739 | Temporal ranking scheme for desktop searching |
| 9 | D591,304 | Graphical user interface for display screen of a communications terminal |
| 10 | 7,526,475 | Library citation integration |
| 11 | 7,525,207 | Water-based data center |
| 12 | 7,523,099 | Category suggestions relating to a search |
| 13 | 7,523,096 | Methods and systems for personalized network searching |
| 14 | 7,523,087 | Determining and/or designating better ad information such as ad landing pages |
| 15 | 7,523,081 | Method and apparatus for producing a signature for an object |
| 16 | 7,523,016 | Detecting anomalies |
| 17 | 7,516,118 | Methods and systems for assisted network browsing |
| 18 | 7,512,620 | Data structure for incremental search |
| 19 | 7,512,487 | Adaptive and personalized navigation system |
| 20 | 7,509,344 | Method for detecting link spam in hyperlinked databases |
| 21 | 7,509,315 | Managing URLs |
| 22 | 7,508,978 | Detection of grooves in scanned images |
| 23 | 7,506,254 | Predictive conversion of user input |
| 24 | 7,505,984 | Systems and methods for information extraction |
| 25 | 7,505,964 | Methods and systems for improving a search ranking using related queries |
| 26 | 7,499,996 | Systems and methods for detecting a memory condition and providing an alert |
| 27 | 7,499,958 | Systems and methods of replicating all or part of a data store |
| 28 | 7,499,940 | Method and system for URL autocompletion using ranked results |
| 29 | 7,496,589 | Highly compressed randomly accessed storage of large tables with arbitrary |
| | | columns |
| 30 | 7,487,447 | Web page zoom feature |
| 31 | 7,487,145 | Method and system for autocompletion using ranked results |
| 32 | 7,483,951 | Method and system for selectively blocking delivery of electronic mail |
| 33 | 7,483,881 | Determining unambiguous geographic references |
| 34 | 7,479,045 | Power distribution adaptable to different power supplies |
| 35 | 7,478,033 | Systems and methods for translating Chinese pinyin to Chinese characters |
| 36 | 7,475,267 | Systems and methods for delay in startup of multiple components |
| 37 | 7,475,071 | Performing a parallel nearest-neighbor matching operation using a parallel hybrid |
| | | spill tree |
| 38 | 7,475,063 | Augmenting queries with synonyms selected using language statistics |
| 39 | 7,469,827 | Vehicle information systems and methods |
| 40 | 7,469,059 | Reorganization of raw image data for processing |
| 41 | 7,467,131 | Method and system for query data caching and optimization in a search engine |
| | | system |
| 42 | 7,464,090 | Object categorization for information extraction |
| 43 | 7,463,772 | De-warping of scanned images |
| 44 | 7,460,863 | Method and apparatus using geographical position to provide authenticated, secure, |
| | | radio frequency communication between a gaming host and a remote gaming |
| | | device |
| 45 | 7,460,735 | Systems and methods for using image duplicates to assign labels to images |
| 46 | 7,454,417 | Methods and systems for improving a search ranking using population information |
| 47 | 7,454,398 | Support for object search |
| 48 | 7,453,921 | LPC filter for removing periodic and quasi-periodic interference from spread |
| | | spectrum signals |
| 49 | 7,451,398 | Providing capitalization correction for unstructured excerpts |
| 50 | 7,451,130 | System and method for providing preferred country biasing of search results |
| 51 | 7,451,129 | System and method for providing preferred language ordering of search results |
| 52 | 7,451,120 | Detecting novel document content |
| 53 | 7,447,678 | Interface for a universal search engine |
| 54 | 7,440,968 | Query boosting based on classification |
| 55 | 7,437,364 | System and method of accessing a document efficiently through multi-tier web |
| | | caching |
| 56 | 7,437,353 | Systems and methods for unification of search results |
| 57 | 7,437,351 | Method for searching media |
| 58 | 7,428,555 | Real-time, computer-generated modifications to an online advertising program |
| 59 | 7,428,524 | Large scale data storage in sparse tables |
| 60 | 7,428,410 | Value-added electronic messaging services having web-based user accessible |
| | | message center |
| 61 | 7,426,507 | Automatic taxonomy generation in search results using phrases |
| 62 | 7,424,682 | Electronic messages with embedded musical note emoticons |
| 63 | 7,424,478 | System and method for selecting content for displaying over the internet based |
| | | upon some user input |
| 64 | 7,421,651 | Document segmentation based on visual gaps |
| 65 | 7,421,432 | Hypertext browser assistant |
| 66 | 7,412,708 | Methods and systems for capturing information |
| 67 | 7,409,383 | Locating meaningful stopwords or stop-phrases in keyword-based retrieval |
| | | systems |
| 68 | 7,406,542 | Method and system for assured denotation of application semantics |
| 69 | 7,401,072 | Named URL entry |
| 70 | 7,392,244 | Methods and apparatus for determining equivalent descriptions for an information |
| | | need |
| 71 | 7,392,017 | Assessing wireless network quality |
| 72 | 7,386,616 | System and method for providing load balanced processing |
| 73 | 7,386,543 | System and method for supporting editorial opinion in the ranking of search |
| | | results |
| 74 | 7,386,438 | Identifying language attributes through probabilistic analysis |
| 75 | D570,359 | Graphic user interface of page turning elements for a display screen of a |
| | | communications terminal |
| 76 | 7,383,258 | Method and apparatus for characterizing documents based on clusters of related |
| | | words |
| 77 | 7,379,811 | Digital mapping system |
| 78 | 7,373,337 | Method and apparatus for event modeling |
| 79 | 7,373,246 | Using boundaries associated with a map view for business location searching |
| 80 | 7,366,718 | Detecting duplicate and near-duplicate files |
| 81 | 7,366,668 | Voice interface for a search engine |
| 82 | 7,363,291 | Methods and apparatus for increasing efficiency of electronic document delivery |
| | | to users |
| 83 | 7,363,001 | Dynamic data delivery apparatus and method for same |
| 84 | D566,716 | Display screen with graphical user interface |
| 85 | 7,359,894 | Methods and systems for requesting and providing information in a social |
| | | network |
| 86 | 7,353,114 | Markup language for an interactive geographic information system |
| 87 | 7,352,833 | Method and system for temporal autocorrelation filtering |
| 88 | 7,350,187 | System and methods for automatically creating lists |
| 89 | 7,349,876 | Determining a minimum price |
| 90 | 7,346,839 | Information retrieval based on historical data |
| 91 | 7,346,615 | Using match confidence to adjust a performance threshold |
| 92 | 7,346,606 | Rendering advertisements with documents having one or more topics using user |
| | | topic interest |
| 93 | 7,333,976 | Methods and systems for processing contact information |
| 94 | D561,193 | Display device showing user interface |
| 95 | 7,319,994 | Document compression scheme that supports searching and partial decompression |
| 96 | 7,315,880 | Method, system, and graphical user interface for dynamically updating |
| | | transmission characteristics in a web mail reply |
| 97 | 7,315,726 | Dynamic data delivery apparatus and method for same |
| 98 | 7,315,259 | Techniques for displaying and caching tiled map data on constrained-resource |
| | | services |
| 99 | 7,313,361 | Dynamic data delivery apparatus and method for same |
| 100 | 7,313,360 | Dynamic data delivery apparatus and method for same |
| 101 | 7,313,359 | Dynamic data delivery apparatus and method for same |
| 102 | 7,310,633 | Methods and systems for generating textual information |
| 103 | 7,308,643 | Anchor tag indexing in a web crawler system |
| 104 | 7,305,610 | Distributed crawling of hyperlinked documents |
| 105 | 7,305,380 | Systems and methods for performing in-context searching |
| 106 | 7,302,645 | Methods and systems for identifying manipulated articles |
| 107 | 7,302,608 | Systems and methods for automatic repair and replacement of networked |
| | | machines |
| 108 | 7,296,016 | Systems and methods for performing point-of-view searching |
| 109 | 7,281,008 | Systems and methods for constructing a query result set |
| 110 | 7,278,273 | Modular data center |
| 111 | 7,272,601 | Systems and methods for associating a keyword with a user interface area |
| 112 | 7,269,621 | Method system and graphical user interface for dynamically updating |
| | | transmission characteristics in a web mail reply |
| 113 | 7,260,573 | Personalizing anchor text scores in a search engine |
| 114 | 7,254,689 | Decompression of block-sorted data |
| 115 | 7,254,580 | System and method for selectively searching partitions of a database |
| 116 | 7,249,121 | Identification of semantic units from within a search query |
| 117 | 7,239,959 | Method and apparatus for customizing travel directions |
| 118 | 7,231,399 | Ranking documents based on large data sets |
| 119 | 7,231,393 | Method and apparatus for learning a probabilistic generative model for text |
| 120 | 7,225,207 | Server for geospatially organized flat file data |
| 121 | 7,222,299 | Detecting quoted text |
| 122 | 7,222,127 | Large scale machine learning systems and methods |
| 123 | 7,222,119 | Namespace locking scheme |
| 124 | 7,213,198 | Link based clustering of hyperlinked documents |
| 125 | D541,291 | Graphic user interface for a display screen |
| 126 | 7,209,148 | Generating, storing, and displaying graphics using sub-pixel bitmaps |
| 127 | 7,203,684 | Serving content-targeted ADS in e-mail, such as e-mail newsletters |
| 128 | 7,194,684 | Method of spell-checking search queries |
| 129 | 7,194,515 | Method and system for selectively blocking delivery of bulk electronic mail |
| 130 | D537,834 | Graphical user interface for a display screen |
| 131 | 7,174,346 | System and method for searching an extended database |
| 132 | 7,158,961 | Methods and apparatus for estimating similarity |
| 133 | 7,158,878 | Digital mapping system |
| 134 | D533,561 | Graphical user interface |
| 135 | 7,146,358 | Systems and methods for using anchor text as parallel corpora for cross-language |
| | | information retrieval |
| 136 | 7,142,536 | Communications network quality of service system and method for real time |
| | | information |
| 137 | 7,136,875 | Serving advertisements based on content |
| 138 | 7,136,854 | Methods and apparatus for providing search results in response to an ambiguous |
| | | search query |
| 139 | D529,920 | Graphical user interface for a display screen of a communications terminal |
| 140 | D529,037 | Graphical user interface for a display screen of a communications terminal |
| 141 | D529,036 | Graphical user interface for a display screen of a communications terminal |
| 142 | 7,113,409 | Mounting structures for electronics components |
| 143 | D528,553 | Graphical user interface for a display screen of a communications terminal |
| 144 | D528,552 | Graphical user interface for a display screen of a communications terminal |
| 145 | 7,107,419 | Systems and methods for performing record append operations |
| 146 | 7,096,214 | System and method for supporting editorial opinion in the ranking of search |
| | | results |
| 147 | 7,089,490 | Identifying navigation bars and objectionable navigation bars |
| 148 | 7,089,237 | Interface and system for providing persistent contextual relevance for commerce |
| | | activities in a networked environment |
| 149 | 7,068,192 | System and method for encoding and decoding variable-length data |
| 150 | 7,065,618 | Leasing scheme for data-modifying operations |
| 151 | 7,031,961 | System and method for searching and recommending objects from a categorically |
| | | organized information repository |
| 152 | 7,031,954 | Document retrieval system with access control |
| 153 | 7,028,029 | Adaptive computation of ranking |
| 154 | 7,027,987 | Voice interface for a search engine |
| 155 | 6,982,945 | Baseband direct sequence spread spectrum transceiver |
| 156 | 6,941,293 | Methods and apparatus for determining equivalent descriptions for an information |
| | | need |
| 157 | 6,934,634 | Address geocoding |
| 158 | 6,906,920 | Drive cooling baffle |
| 159 | 6,870,095 | Cable management for rack mounted computing system |
| 160 | 6,865,575 | Methods and apparatus for using a modified index to provide search results in |
| | | response to an ambiguous search query |
| 161 | 6,845,009 | Cooling baffle and fan mount apparatus |
| 162 | 6,839,702 | Systems and methods for highlighting search results |
| 163 | 6,754,873 | Techniques for finding related hyperlinked documents using link-based analysis |
| 164 | 6,725,259 | Ranking search results by reranking the results based on local inter-connectivity |
| 165 | 6,678,681 | Information extraction from a database |
| 166 | 6,658,423 | Detecting duplicate and near-duplicate files |
| 167 | 6,615,209 | Detecting query-specific duplicate documents |
| 168 | 6,529,903 | Methods and apparatus for using a modified index to provide search results in |
| | | response to an ambiguous search query |
| 169 | 6,526,440 | Ranking search results by reranking the results based on local inter-connectivity |

Google published patent applications

| | PUB. APP. | |
|---|---|---|
| | NO. | Title |
| 1 | 20090132346 | Modifying Broadcast Media Ad Campaigns |
| 2 | 20090132197 | Activating Applications Based on Accelerometer Data |
| 3 | 20090125371 | Domain-Specific Sentiment Classification |
| 4 | 20090119166 | VIDEO ADVERTISEMENTS |
| 5 | 20090113444 | Application Management |
| 6 | 20090112857 | Methods and Systems for Improving a Search Ranking Using Related Queries |
| 7 | 20090112685 | USER GENERATED ADVERTISING |
| 8 | 20090106087 | CONTEXTUAL AUCTION BIDDING |
| 9 | 20090106070 | Online Advertisement Effectiveness Measurements |
| 10 | 20090100036 | Methods and Systems for Classifying Search Results to Determine Page |
| | | Elements |
| 11 | 20090099901 | External Referencing By Portable Program Modules |
| 12 | 20090094697 | INTRUSIVE SOFTWARE MANAGEMENT |
| 13 | 20090094224 | COLLABORATIVE SEARCH RESULTS |
| 14 | 20090094175 | INTRUSIVE SOFTWARE MANAGEMENT |
| 15 | 20090089169 | Event Based Serving |
| 16 | 20090083243 | CROSS-LANGUAGE SEARCH |
| 17 | 20090083028 | AUTOMATIC CORRECTION OF USER INPUT BASED ON |
| | | DICTIONARY |
| 18 | 20090077115 | MEDIA PLAN MANAGING |
| 19 | 20090076970 | System and method for sending actionable offer alerts in electronic messages |
| 20 | 20090076927 | DISTINGUISHING ACCESSORIES FROM PRODUCTS FOR RANKING |
| | | SEARCH RESULTS |
| 21 | 20090076901 | GENERATING ADVERTISEMENTS USING USER ASSETS |
| 22 | 20090076886 | ADVERTISEMENT PLUSBOX |
| 23 | 20090070706 | Placement Attribute Targeting |
| 24 | 20090070312 | INTEGRATING EXTERNAL RELATED PHRASE INFORMATION INTO |
| | | A PHRASE-BASED INDEXING INFORMATION RETRIEVAL SYSTEM |
| 25 | 20090070098 | Dynamic Virtual Input Device Configuration |
| 26 | 20090070097 | USER INPUT CLASSIFICATION |
| 27 | 20090064329 | Zero-hour quarantine of suspect electronic messages |
| 28 | 20090063953 | Collaborative Web Page Authoring |
| 29 | 20090063462 | WORD DECOMPOUNDER |
| 30 | 20090063452 | SEARCH FILTERING |
| 31 | 20090063425 | INTERFACE FOR A UNIVERSAL SEARCH |
| 32 | 20090063229 | ADVERTISER AD REVIEW |
| 33 | 20090055725 | System and Method for Generating Creatives Using Composite Templates |
| 34 | 20090055394 | IDENTIFYING KEY TERMS RELATED TO SIMILAR PASSAGES |
| 35 | 20090055392 | ORDERING OF SEARCH RESULTS BASED ON LANGUAGE AND/OR |
| | | COUNTRY OF THE SEARCH RESULTS |
| 36 | 20090055389 | Ranking similar passages |
| 37 | 20090055385 | Media-Based Recommendations |
| 38 | 20090055381 | Domain Dictionary Creation |
| 39 | 20090055375 | Bundle Generation |
| 40 | 20090055168 | Word Detection |
| 41 | 20090049646 | Electronic Device wih Hinge Mechanism |
| 42 | 20090044125 | Content Server Latency Demonstration |
| 43 | 20090043649 | Content Item Pricing |
| 44 | 20090040927 | Content Server Latency Determination |
| 45 | 20090037837 | Language Keyboard |
| 46 | 20090037267 | Customized Distribution of Advertising Impressions |
| 47 | 20090024700 | AD TARGETING USING REFERENCE PAGE INFORMATION |
| 48 | 20090024606 | Identifying and Linking Similar Passages in a Digital Text Corpus |
| 49 | 20090024595 | AUTOMATIC EXPANDED LANGUAGE SEARCH |
| 50 | 20090024470 | VERTICAL CLUSTERING AND ANTI-CLUSTERING OF CATEGORIES |
| | | IN AD LINK UNITS |
| 51 | 20090019028 | INTERPRETING LOCAL SEARCH QUERIES |
| 52 | 20090019011 | Processing Digitally Hosted Volumes |
| 53 | 20090006389 | NAMED URL ENTRY |
| 54 | 20090006375 | Selection of Advertisements for Placement with Content |
| 55 | 20090006207 | Using Previous User Search Query To Target Advertisements |
| 56 | 20090006191 | TARGETING IN-VIDEO ADVERTISING |
| 57 | 20090006190 | DETERMINING LOCATION-BASED COMMERCIAL INFORMATION |
| 58 | 20090006145 | Booking Advertising Campaigns |
| 59 | 20080319962 | Machine Translation for Query Expansion |
| 60 | 20080301672 | Installation of a Software Product on a Device with Minimal User |
| | | Interaction |
| 61 | 20080301669 | Dynamically Self-Updating by a Software Application on a Device |
| 62 | 20080301667 | Dynamically Updating Software Applications on a Device |
| 63 | 20080301660 | Maintaining Multiple Versions of a Software Application on a Device |
| 64 | 20080301643 | Map Gadgets |
| 65 | 20080301093 | Determining Search Query Statistical Data for an Advertising Campaign |
| | | Based on User-Selected Criteria |
| 66 | 20080300974 | Flexible Revenue Sharing and Referral Bounty System |
| 67 | 20080294603 | Providing Profile Information to Partner Content Providers |
| 68 | 20080294549 | PROCESSING ELECTRONIC TEARSHEETS |
| 69 | 20080294524 | Site-Targeted Advertising |
| 70 | 20080294516 | ELECTRONIC ADVERTISING SYSTEM |
| 71 | 20080292213 | ANNOTATIONS IN PANORAMIC IMAGES, AND APPLICATIONS |
| | | THEREOF |
| 72 | 20080291217 | VIEWING AND NAVIGATING WITHIN PANORAMIC IMAGES, AND |
| | | APPLICATIONS THEREOF |
| 73 | 20080291201 | EFFICIENT RENDERING OF PANORAMIC IMAGES, AND |
| | | APPLICATIONS THEREOF |
| 74 | 20080288509 | DUPLICATE CONTENT SEARCH |
| 75 | 20080288474 | CROSS-LANGUAGE INFORMATION RETRIEVAL |
| 76 | 20080282151 | DOCUMENT SEGMENTATION BASED ON VISUAL GAPS |
| 77 | 20080281674 | DETERMINING METRICS ASSOCIATED WITH ADVERTISING |
| | | SPECIALIST |
| 78 | 20080276272 | Animated Video Overlays |
| 79 | 20080276266 | CHARACTERIZING CONTENT FOR IDENTIFICATION OF |
| | | ADVERTISING |
| 80 | 20080275899 | Advertiser and User Association |
| 81 | 20080275861 | Inferring User Interests |
| 82 | 20080275811 | Flexible Advertiser Billing System with Mixed Postpayment and |
| | | Prepayment Capabilities |
| 83 | 20080275757 | Metric Conversion for Online Advertising |
| 84 | 20080271080 | Customizable Media Channels |
| 85 | 20080271078 | Momentary Electronic Program Guide |
| 86 | 20080270886 | Hiding Portions of Display Content |
| 87 | 20080270449 | Program Guide User Interface |
| 88 | 20080270364 | EXPANSION RULE EVALUATION |
| 89 | 20080263583 | CONTENT RECOGNITION FOR TARGETING VIDEO |
| | | ADVERTISEMENTS |
| 90 | 20080263578 | Forecasting TV Impressions |
| 91 | 20080262828 | Encoding and Adaptive, Scalable Accessing of Distributed Models |
| 92 | 20080256109 | Dynamic Podcast Content Delivery |
| 93 | 20080255904 | Estimating Off-Line Advertising Impressions |
| 94 | 20080255686 | Delivering Podcast Content |
| 95 | 20080254741 | Leader and Follower Broadcast Stations |
| 96 | 20080253307 | Multi-Station Media Controller |
| 97 | 20080250453 | Log Processing |
| 98 | 20080250448 | Log Processing |
| 99 | 20080250447 | Log Processing |
| 100 | 20080250446 | ADVERTISEMENT FRONT END |
| 101 | 20080250445 | TELEVISION ADVERTISING |
| 102 | 20080249850 | Providing Information About Content Distribution |
| 103 | 20080249834 | Adjusting for Uncertainty in Advertisement Impression Data |
| 104 | 20080249786 | IDENTIFYING INADEQUATE SEARCH CONTENT |
| 105 | 20080243780 | OPEN PROFILE CONTENT IDENTIFICATION |
| 106 | 20080243607 | RELATED ENTITY CONTENT IDENTIFICATION |
| 107 | 20080243601 | ADVERTISEMENT INVENTORY PROCESSING |
| 108 | 20080243526 | CUSTODIAN BASED CONTENT IDENTIFICATION |
| 109 | 20080243501 | Location-Based Responses to Telephone Requests |
| 110 | 20080235085 | VIRTUAL ADVERTISEMENT STORE |
| 111 | 20080232574 | Flexible Communication Systems and Methods |
| 112 | 20080215553 | Personalized Network Searching |
| 113 | 20080209234 | Water-Based Data Center |
| 114 | 20080204999 | Targeted Cooling for Datacenters |
| 115 | 20080201734 | Association of Ads With Tagged Audiovisual Content |
| 116 | 20080201437 | SYSTEMS AND METHODS FOR VIEWING MEDIA CONTENT IN |
| | | INSTANT MESSAGING |
| 117 | 20080201186 | IDENTIFYING ADVERTISING SPECIALIST |
| 118 | 20080193015 | CONTEXTUAL INPUT METHOD |
| 119 | 20080189249 | Searching Structured Geographical Data |
| 120 | 20080183699 | BLENDING MOBILE SEARCH RESULTS |
| 121 | 20080183660 | CONTENT IDENTIFICATION EXPANSION |
| 122 | 20080183593 | On-Line Payment Transactions |
| 123 | 20080183377 | USING BOUNDARIES ASSOCIATED WITH A MAP VIEW FOR |
| | | BUSINESS LOCATION SEARCHING |
| 124 | 20080172374 | Presentation of Local Results |
| 125 | 20080172373 | Synchronization of Fixed and Mobile Data |
| 126 | 20080172372 | Expandable Homepage Modules |
| 127 | 20080172362 | Providing Relevance-Ordered Categories of Information |
| 128 | 20080172357 | LOCATION IN SEARCH QUERIES |
| 129 | 20080168032 | KEYWORD-BASED CONTENT SUGGESTIONS |
| 130 | 20080167957 | Integrating Placement of Advertisements in Multiple Media Types |
| 131 | 20080162603 | DOCUMENT ARCHIVING SYSTEM |
| 132 | 20080162602 | DOCUMENT ARCHIVING SYSTEM |
| 133 | 20080162277 | PROVIDING ADVERTISING |
| 134 | 20080162260 | NETWORK NODE AD TARGETING |
| 135 | 20080162257 | TRACKING RESPONSES TO ADVERTISEMENTS IN STATIC WEB |
| | | PAGES |
| 136 | 20080160490 | Seeking Answers to Questions |
| 137 | 20080158818 | Motherboards with Integrated Cooling |
| 138 | 20080155340 | Diagnostics and Error Reporting For Common Tagging Issues |
| 139 | 20080154908 | Annotation Framework for Video |
| 140 | 20080154684 | Targeted Content Request |
| 141 | 20080140647 | Interleaving Search Results |
| 142 | 20080130960 | Identifying Images Using Face Recognition |
| 143 | 20080126415 | Digital Image Archiving and Retrieval in a Mobile Device System |
| 144 | 20080126192 | System and Methods for Distributing Sales of Advertisement Slots |
| 145 | 20080120165 | Large-Scale Aggregating and Reporting of Ad Data |
| 146 | 20080115161 | DELIVERING USER-SELECTED VIDEO ADVERTISEMENTS |
| 147 | 20080114729 | Computer-implemented interactive, virtual bookshelf system and method |
| 148 | 20080107338 | Media material analysis of continuing article portions |
| 149 | 20080107337 | Methods and systems for analyzing data in media material having layout |
| 150 | 20080107159 | METHOD AND SYSTEM FOR TEMPORAL AUTOCORRELATION |
| | | FILTERING |
| 151 | 20080104194 | CONTENT REQUEST OPTIMIZATION |
| 152 | 20080103887 | SELECTING ADVERTISEMENTS BASED ON CONSUMER |
| | | TRANSACTIONS |
| 153 | 20080103885 | RESOURCE MANAGEMENT |
| 154 | 20080103883 | Providing Feedback to an Offer for Advertising Space |
| 155 | 20080103879 | USER-SPECIFIED ONLINE ADVERTISING |
| 156 | 20080098058 | Online Ranking Protocol |
| 157 | 20080098032 | MEDIA INSTANCE CONTENT OBJECTS |
| 158 | 20080097987 | Online Ranking Metric |
| 159 | 20080097986 | Generic Online Ranking System and Method Suitable for Syndication |
| 160 | 20080092159 | TARGETED VIDEO ADVERTISING |
| 161 | 20080086368 | Location Based, Content Targeted Online Advertising |
| 162 | 20080082400 | Advertisement Campaign Simulator |
| 163 | 20080077264 | Digital Audio File Management |
| 164 | 20080071544 | Integrating Voice-Enabled Local Search and Contact Lists |
| 165 | 20080066107 | Using Viewing Signals in Targeted Video Advertising |
| 166 | 20080065694 | Local Search Using Address Completion |
| 167 | 20080046315 | Realizing revenue from advertisement placement |
| 168 | 20080040318 | System and Method for Generating Creatives |
| 169 | 20080040221 | Interest Targeting |
| 170 | 20080028303 | Fault-Tolerant Romanized Input Method for Non-Roman Characters |
| 171 | 20080022267 | Method and System for Dynamically Composing Distributed |
| | | Interactive Applications from High-Level Programming Languages |
| 172 | 20080016472 | Markup Language for Interactive Geographic Information System |
| 173 | 20080010252 | BOOKMARKS AND RANKING |
| 174 | 20070300152 | Formatting a user network site based on user preferences and format |
| | | performance data |
| 175 | 20070283049 | Resolving Conflicts While Synchronizing Configuration Information |
| | | Among Multiple Clients |
| 176 | 20070283011 | Synchronizing Configuration Information Among Multiple Clients |
| 177 | 20070282792 | Identifying Geo-Located Objects |
| 178 | 20070271501 | Encoding and Displaying Default Landing Page Content |
| 179 | 20070271262 | Systems and Methods for Associating a Keyword With a User Interface |
| | | Area |
| 180 | 20070266342 | WEB NOTEBOOK TOOLS |
| 181 | 20070266022 | Presenting Search Result Information |
| 182 | 20070266011 | Managing and Accessing Data in Web Notebooks |
| 183 | 20070260671 | CUSTOMIZATION OF CONTENT AND ADVERTISEMENTS IN |
| | | PUBLICATIONS |
| 184 | 20070260508 | Method and system for providing advertising through content specific |
| | | nodes over the internet |
| 185 | 20070250477 | Ranking and Clustering of Geo-Located Objects |
| 186 | 20070249368 | Shared Geo-Located Objects |
| 187 | 20070239716 | Generating Specialized Search Results in Response to Patterned |
| | | Queries |
| 188 | 20070198500 | USER DISTRIBUTED SEARCH RESULTS |
| 189 | 20070179952 | DISPLAYING FACTS ON A LINEAR GRAPH |
| 190 | 20070176796 | Local Search and Mapping for Mobile Devices |
| 191 | 20070169146 | Media Play Optimization |
| 192 | 20070168542 | Media Article Adaptation to Client Device |
| 193 | 20070168541 | Serving Media Articles with Altered Playback Speed |
| 194 | 20070168254 | Media Play Optimization |
| 195 | 20070162611 | Discontinuous Download of Media Files |
| 196 | 20070162571 | Combining and Serving Media Content |
| 197 | 20070143778 | Determining Popularity Ratings Using Social and Interactive |
| | | Applications for Mass Media |
| 198 | 20070136443 | Proxy server collection of data for module incorporation into a |
| | | container document |
| 199 | 20070136337 | Module specification for a module to be incorporated into a container |
| | | document |
| 200 | 20070136320 | Remote module incorporation into a container document |
| 201 | 20070136201 | Customized container document modules using preferences |
| 202 | 20070133034 | Detecting and rejecting annoying documents |
| 203 | 20070130580 | Social and Interactive Applications for Mass Media |
| 204 | 20070130126 | USER DISTRIBUTED SEARCH RESULTS |
| 205 | 20070124756 | Detecting Repeating Content in Broadcast Media |
| 206 | 20070118520 | Local Search and Mapping for Mobile Devices |
| 207 | 20070100817 | DOCUMENT SCORING BASED ON DOCUMENT CONTENT UPDATE |
| 208 | 20070094255 | DOCUMENT SCORING BASED ON LINK-BASED CRITERIA |
| 209 | 20070094254 | DOCUMENT SCORING BASED ON DOCUMENT INCEPTION DATE |
| 210 | 20070088693 | DOCUMENT SCORING BASED ON TRAFFIC ASSOCIATED WITH A |
| | | DOCUMENT |
| 211 | 20070088692 | DOCUMENT SCORING BASED ON QUERY ANALYSIS |
| 212 | 20070073696 | Online data verification of listing data |
| 213 | 20070038659 | Scalable user clustering based on set similarity |
| 214 | 20060287913 | Allocating advertising space in a network of displays |
| 215 | 20060230350 | Nonstandard locality-based text entry |
| 216 | 20060224938 | Systems and methods for providing a graphical display of search activity |
| 217 | 20060224624 | Systems and methods for managing multiple user accounts |
| 218 | 20060224615 | Systems and methods for providing subscription-based personalization |
| 219 | 20060224608 | Systems and methods for combining sets of favorites |
| 220 | 20060224587 | Systems and methods for modifying search results based on a user's history |
| 221 | 20060224583 | Systems and methods for analyzing a user's web history |
| 222 | 20060224582 | User interface for facts query engine with snippets from information sources |
| | | that include query terms and answer terms |
| 223 | 20060200445 | Providing history and transaction volume information of a content source to |
| | | users |
| 224 | 20060156387 | Methods and systems for opportunistic cookie caching |
| 225 | 20050289463 | Systems and methods for spell correction of non-roman characters and words |
| 226 | 20050246588 | Profile based capture component |
| 227 | 20050209844 | Systems and methods for translating chinese pinyin to chinese characters |
| 228 | 20050149851 | Generating hyperlinks and anchor text in HTML and non-HTML documents |
| 229 | 20050149576 | Systems and methods for direct navigation to specific portion of target |
| | | document |
| 230 | 20050149499 | Systems and methods for improving search quality |
| 231 | 20040261021 | Systems and methods for searching using queries written in a different |
| | | character-set and/or language from the target pages |
| 232 | 20040122811 | Method for searching media |
| 233 | 20040119740 | Methods and apparatus for displaying and replying to electronic messages |
| 234 | 20040059708 | Methods and apparatus for serving relevant advertisements |
| 235 | 20020133481 | Methods and apparatus for providing search results in response to an |
| | | ambiguous search query |
| 236 | 20020123988 | Methods and apparatus for employing usage statistics in document retrieval |
| 237 | 20020042791 | Methods and apparatus for using a modified index to provide search results |
| | | in response to an ambiguous search query |

Facebook published patent applications

| | PUB. APP. | |
|---|---|---|
| | NO. | |
| 1 | 20080046976 | Systems and methods for dynamically generating |
| | | a privacy summary |
| 2 | 20080033739 | Systems and methods for dynamically generating |
| | | segmented community flyers |

eHarmony published patent application

| | | |
|---|---|---|
| 1 | 20090106043 | Method and system for identifying people who |
| | | are likely to have a successful relationship |

Match.com published patent applications

| | PUB. APP. NO. | |
|---|---|---|
| 1 | 20090070133 | System and Method for Providing a Near |
| | | Matches Feature in a Network Environment |
| 2 | 20070073803 | System and method for providing a post-date |
| | | component in a network environment |
| 3 | 20070073802 | System and method for providing on-line |
| | | dating features in a network environment |
| 4 | 20070073711 | System and method for providing a pre-date |
| | | component in a network environment |
| 5 | 20070073710 | System and method for providing a search |
| | | feature in a network environment |
| 6 | 20070073687 | System and method for providing enhanced |
| | | questions for matching in a network |
| | | environment |
| 7 | 20070073549 | System and method for providing testing and |
| | | matching in a network environment |
| 8 | 20070073548 | System and method for providing a system that |
| | | includes on-line and off-line features in a |
| | | network environment |
| 9 | 20070072468 | System and method for providing an enhanced |
| | | selection process in a network environment |

As used herein, to “acquire” has a broad meaning and includes means, for example, to buy, borrow, lease, and/or rent. As used herein, to “possess” has a broad meaning and includes, for example, own and/or license and/or lease, and/or rent. As used herein, a “nonmonetary aspiration” has a broad meaning and includes, for example, a goal and/or desire and/or want.

As used herein, “rent” has a broad meaning and includes having temporary possession, including, for example, borrowing and/or leasing and and/or renting, whether involving a transaction for consideration or not.

As used herein, a “post” by a user can be either a verb, meaning, for example, the act of posting, or inputting or entering, information into a user field or page, such as a web document; or a noun, meaning a posting, i.e., the information so inputted, or posted, by the user. Posting can also imply that the information entered by the user has been accepted and/or published and/or displayed by the network interface or web document with which the user is interacting.

As used herein, “skill” has a broad meaning, including, for example, talent, education, career, job, hobby, proficiency, preoccupation, and interest.

As used herein, “characteristic” of a user or other person has a broad meaning, including, for example, habit, style, quality, trait, personality, idiosyncrasy, or quirk.

As used herein, a “page region,” as in “user page region” or “group page region,” means part or all of one web page, or part or all of multiple web pages.

As used herein, “displaying” means actually presenting information via a display device, or providing information to a device, network, or computer system configured for display, the information capable of being represented in a display.

According to some aspects of the disclosure, a search system may include a search engine and a category suggestion engine. The search engine may receive a search query associated with, for example, a geographic area, and identify a group of documents that are associated with locations in the geographic area based on the search query. The category suggestion engine may identify categories associated with documents in the group of documents, score the categories, and present one or more highest-scoring ones of the categories as one or more category suggestions.

Some aspects of the disclosure relate generally to improved techniques for analyzing large directed graphs for use in computer systems, and to reducing the computational complexity of assigning ranks to nodes. Some embodiments include iteratively solving a ranking function for a set of document rank values with respect to a set of linked documents until a first stability condition is satisfied. The ranking function is modified so as to reduce the ranking function's computation cost and then the modified ranking function is solved until a second stability condition is satisfied.

Determining an existence of an association between two or more things, such as between two search queries, or between a search query and a document, refers to determining at least whether such an association exists, and possibly, although not necessarily, determining more attributes or information concerning the association.

In an attempt to increase the relevancy and quality of the web pages returned to the user, a search engine may attempt to sort the list of hits so that the most relevant and/or highest quality pages are at the top of the list of hits returned to the user. For example, the search engine may assign a rank or score to each hit, where the score is designed to correspond to the relevance or importance of the web page. Determining appropriate scores can be a difficult task. The importance of a web page to the user is inherently subjective and depends on the user's interests, knowledge, and attitudes. There is, however, much that can be determined objectively about the relative importance of a web page. Conventional methods of determining relevance are based on the contents of the web page. More advanced techniques determine the importance of a web page based on more than the content of the web page. For example, one known method, described in the article entitled “The Anatomy of a Large-Scale Hypertextual Search Engine,” by Sergey Brin and Lawrence Page, assigns a degree of importance to a web page based on the link structure of the web page. In other words, the Brin and Page algorithm attempts to quantify the importance of a web page based on more than just the content of the web page.

A primary goal of a search engine is to return the most desirable set of results for any particular search query. Thus, it is desirable to improve the ranking algorithm used by search engines and to therefore provide users with better search results.

Although link-based ranking techniques are improvements over prior techniques, in the case of an extremely large database, such as the world wide web, which contains billions of pages, the computation of the ranks for all the pages can take considerable time. Accordingly, techniques for calculating page ranks with greater computational efficiency are desirable.

Systems and methods described herein address this and other needs by providing search engine techniques that refine a document's relevance score based on inter-connectivity of the document within a set of relevant documents.

It can be useful for various purposes to rank or assign importance values to nodes in a large linked database. For example, the relevance of database search results can be improved by sorting the retrieved nodes according to their ranks, and presenting the most important, highly ranked nodes first. Alternately, the search results can be sorted based on a query score for each document in the search results, where the query score is a function of the document ranks as well as other factors.

One approach to ranking documents involves examining the intrinsic content of each document or the back-link anchor text in parents of each document. This approach can be computationally intensive and often fails to assign highest ranks to the most important documents. Another approach to ranking involves examining the extrinsic relationships between documents, i.e., from the link structure of the directed graph, in an approach called link-based ranking. For example, U.S. Pat. No. 6,285,999 to Page discloses a technique used by the Google search engine for assigning a rank to each document in a hypertext database. According to the link-based ranking method of Page, the rank of a node is recursively defined as a function of the ranks of its parent nodes. Looked at another way, the rank of a node is the steady-state probability that an arbitrarily long random walk through the network will end up at the given node. Thus, a node will tend to have a high rank if it has many parents, or if its parents have high rank.

The following description refers to the accompanying drawings. The detailed description does not limit the invention. Instead, the scope of the invention is defined by the appended claims and equivalents.

As described herein, a search engine modifies the relevance rankings for a set of documents based on the inter-connectivity of the documents in the set. A document with a high inter-connectivity with other documents in the initial set of relevant documents indicates that the document has “support” in the set, and the document's new ranking will increase. In this manner, the search engine re-ranks the initial set of ranked documents to thereby refine the initial rankings.

The following detailed description of the invention refers to the accompanying drawings. The same reference numbers in different drawings may identify the same or similar elements. The following description does not limit the invention.

General Overview

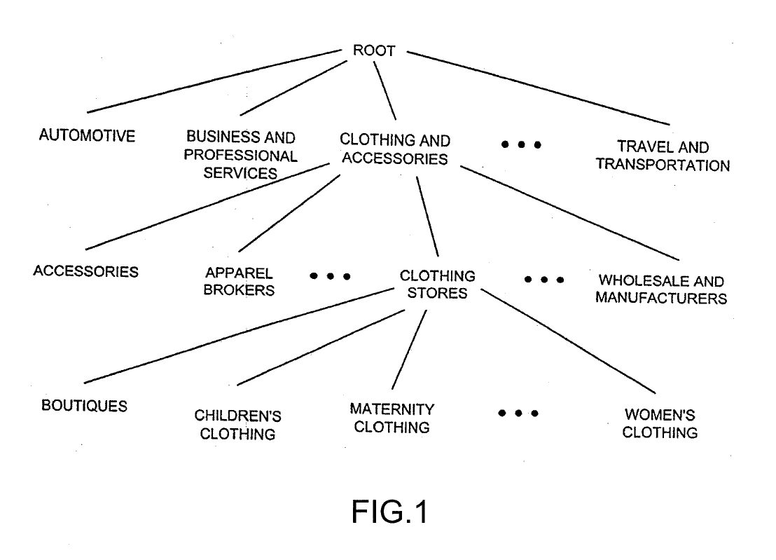

FIG. 1 is a diagram of a web directory of business listings. As shown in FIG. 1, the directory includes categories that form a hierarchy. The “clothing and accessories” category, for example, is shown as including several sub-categories (e.g., “accessories,” “apparel brokers,” “clothing stores,” and “wholesale and manufacturers”) and sub-sub-categories (e.g., “boutiques,” “children's clothing,” “maternity clothing,” and “women's clothing”). Business listings may be assigned to the appropriate categories. For example, a business that sells maternity clothing may be assigned to the maternity clothing category.

Systems and methods consistent with principles of the disclosure may use information regarding the categories to which documents are assigned to suggest categories that relate to a search. The categories may be used to further define the search or replace the search and present a user with results that are relevant to the user's interests.

A “document,” as the term is used herein, is to be broadly interpreted to include any machine-readable and machine-storable work product. A document may include, for example, an e-mail, a web site, a file, a combination of files, one or more files with embedded links to other files, a news group posting, a blog, a web advertisement, etc. In the context of the Internet, a common document is a web page. Web pages often include textual information and may include embedded information (such as meta information, images, hyperlinks, etc.) and/or embedded instructions (such as Javascript, etc.). A “link,” as the term is used herein, is to be broadly interpreted to include any reference to/from a document from/to another document or another part of the same document.

Exemplary Network Configuration

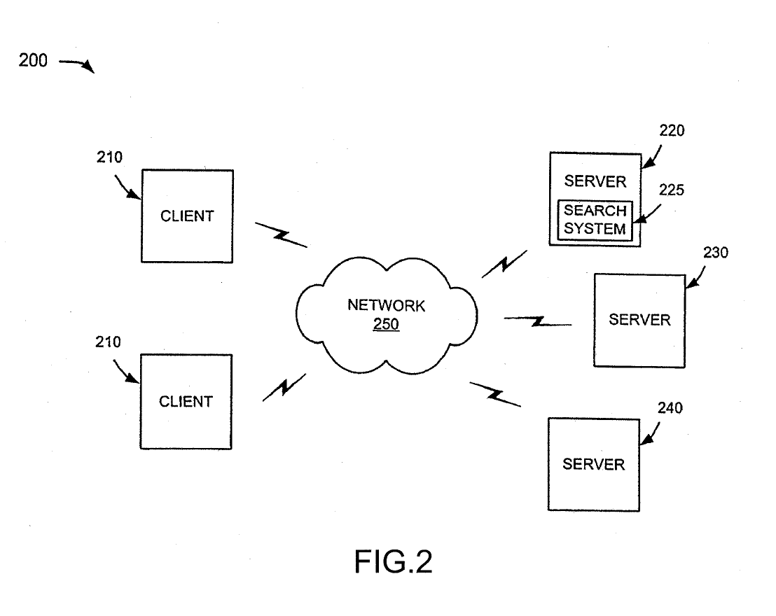

FIG. 2 is an exemplary diagram of a network 200 in which systems and methods consistent with principles of the disclosure may be implemented. Network 200 may include multiple clients 210 connected to multiple servers 220-240 via a network 250. Two clients 210 and three servers 220-240 have been illustrated as connected to network 250 for simplicity. In practice, there may be more or fewer clients and servers. Also, in some instances, a client may perform the functions of a server and a server may perform the functions of a client.

Clients 210 may include client entities. An entity may be defined as a device, such as a wireless telephone, a personal computer, a personal digital assistant (PDA), a lap top, or another type of computation or communication device, a thread or process running on one of these devices, and/or an object executable by one of these devices. Servers 220-240 may include server entities that gather, process, search, and/or maintain documents in a manner consistent with principles of the disclosure.

In an implementation consistent with principles of the disclosure, server 220 may include a search system 225 usable by ‘clients 210. Server 220 may crawl a corpus of documents (e.g., web documents), index the documents, and store information associated with the documents in a repository of documents. Servers 230 and 240 may store or maintain documents that may be crawled or analyzed by server 120.

While servers 220-240 are shown as separate entities, it may be possible for one or more of servers 220-240 to perform one or more of the functions of another one or more of servers 220-240. For example, it may be possible that two or more of servers 220-240 are implemented as a single server. It may also be possible for a single one of servers 220-240 to be implemented as two or more separate (and possibly distributed) devices.

Network 250 may include a local area network (LAN), a wide area network (WAN), a telephone network, such as the Public Switched Telephone Network (PSTN), an intranet, the Internet, a memory device, or a combination of networks. Clients 210 and servers 220-240 may connect to network 250 via wired, wireless, and/or optical connections.

Exemplary Client/Server Architecture

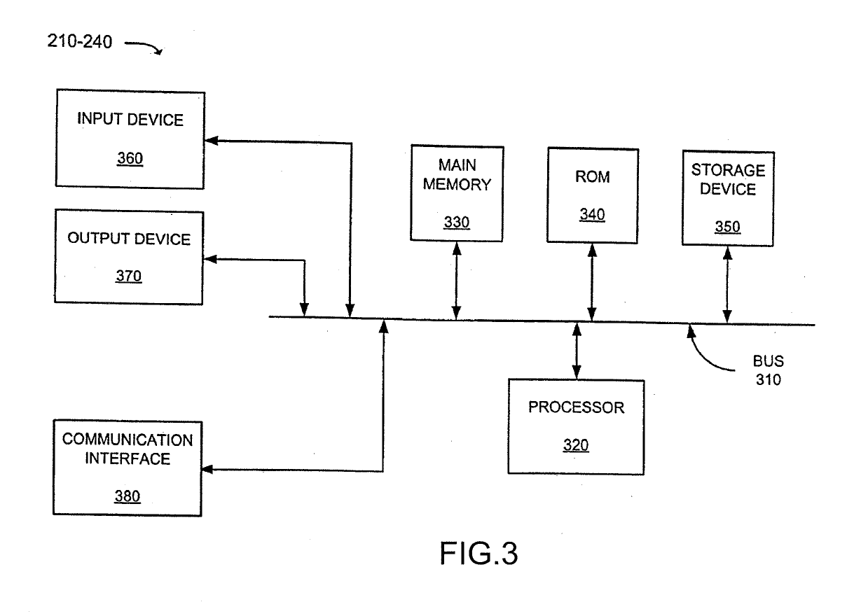

FIG. 3 is an exemplary diagram of a client or server entity (hereinafter called “client/server entity”), which may correspond to one or more of clients 210 and/or servers 220-240, according to an implementation consistent with principles of the disclosure. The client/server entity may include a bus 310, a processor 320, a main memory 330, a read only memory (ROM) 340, a storage device 350, an input device 360, an output device 370, and a communication interface 380. Bus 310 may include a path that permits communication among the elements of the client/server entity.

Processor 320 may include a conventional processor, microprocessor, or processing logic that interprets and executes instructions. Main memory 330 may include a random access memory (RAM) or another type of dynamic storage device that may store information and instructions for execution by processor 320. ROM 340 may include a conventional ROM device or another type of static storage device that may store static information and instructions for use by processor 320. Storage device 350 may include a magnetic and/or optical recording medium and its corresponding drive.

Input device 360 may include a conventional mechanism that permits an operator to input information to the client/server entity, such as a keyboard, a mouse, a pen, voice recognition and/or biometric mechanisms, etc. Output device 370 may include a conventional mechanism that outputs information to the operator, including a display, a printer, a speaker, etc. Communication interface 380 may include any transceiver-like mechanism that enables the client/server entity to communicate with other devices and/or systems. For example, communication interface 380 may include mechanisms for communicating with another device or system via a network, such as network 250.

As will be described in detail below, the client/server entity, consistent with principles of the disclosure, may perform certain document processing-related operations. The client/server entity may perform these operations in response to processor 320 executing software instructions contained in a computer-readable medium, such as memory 330. A computer-readable medium may be defined as a physical or logical memory device and/or carrier wave.

The software instructions may be read into memory 330 from another computer-readable medium, such as data storage device 350, or from another device via communication interface 380. The software instructions contained in memory 330 may cause processor 320 to perform processes that will be described later. Alternatively, hardwired circuitry may be used in place of or in combination with software instructions to implement processes consistent with principles of the disclosure. Thus, implementations consistent with principles of the disclosure are not limited to any specific combination of hardware circuitry and software.

Exemplary Search System

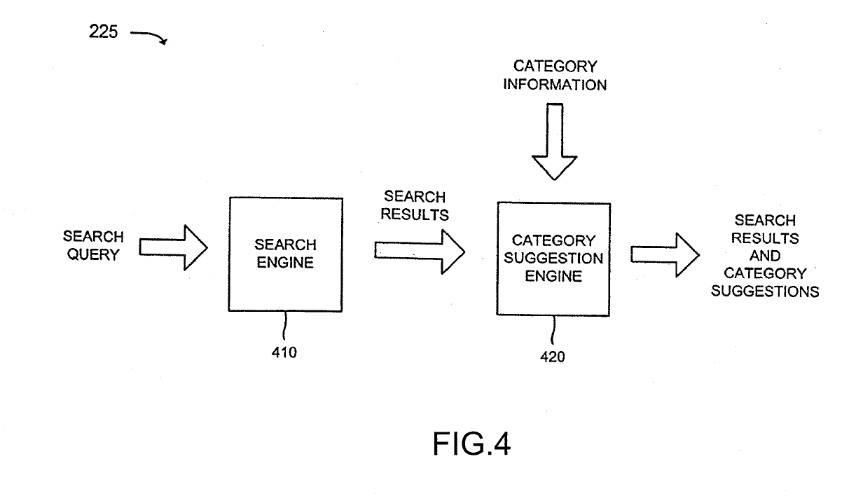

FIG. 4 is an exemplary diagram of a portion of search system 225 according to an implementation consistent with principles of the disclosure. The portion of search system 225 illustrated in FIG. 4 may include search engine 410 and category suggestion engine 420. While search engine 410 and category suggestion engine 420 are shown as separate engines, in practice, search engine 410 may include category suggestion engine 420.

Search engine 410 may include a traditional search engine that returns a ranked set of documents related to a user search query. Search engine 410 may include a general search engine, such as one based on documents from a large corpus, such as documents on the web, or a more specialized search engine, such as a local search engine.

In operation, search engine 410 may receive a user search query. Search engine 410 may identify a set of documents that match the search query by comparing the search terms in the query to documents in the document corpus. There are a number of known techniques that search engine 410 may use to identify documents related to a set of search terms. For example, when the set of search terms includes a single search term, search engine 410 might identify documents that contain the search term. When the set of search terms includes multiple search terms, search engine 410 might identify documents that contain the search terms as a phrase. Alternatively or additionally, search engine 410 might identify documents that contain the search terms, but not necessarily together. Alternatively or additionally, search engine 410 might identify documents that contain less than all of the search terms, or synonyms of the search terms. Yet other techniques for identifying relevant documents are known to those skilled in the art.

Search engine 410 might generate an information retrieval (IR) score for the identified documents. There are a number of known techniques that search engine 410 may use to generate an IR score for a document. For example, search engine 410 may generate an IR score based on the number of occurrences of the search terms in the document. Alternatively or additionally, search engine 410 may generate an IR score based on where the search terms occur within the document (e.g., title, content, etc.) or characteristics of the search terms (e.g., font, size, color, etc.). Alternatively or additionally, search engine 410 may weight a search term differently from another search term when multiple search terms are present. Alternatively or additionally, search engine 410 may consider the proximity of the search terms when multiple search terms are present. Yet other techniques for generating an IR score for a document are known to those skilled in the art.

Search engine 410 may sort the identified documents based on their IR scores and output them as a list of search results to category suggestion engine 420. In another implementation, search engine 410 may generate total scores for the documents based on a combination of their IR scores and link-based scores associated with the documents. Several techniques exist for determining the link-based score of a document. One such technique is described in U.S. Pat. No. 6,285,999, entitled “METHOD FOR NODE RANKING IN A LINKED DATABASE,” the contents of which are incorporated by reference.

Category suggestion engine 420 may suggest one or more categories that relate to the search. In operation, category suggestion engine 420 may identify categories associated with the top N (e.g., 1000) documents in the list of search results. The categories may be obtained from a number of different category providers, such as yellow pages and web directories, or derived using an automatic text classification system. A category associated with a document may be pre-stored with the document in a database associated with server 220. In this case, category suggestion engine 420 may identify the category by looking it up in the database. A document may have one or more associated categories.

Category suggestion engine 420 may score the categories based on the scores of the associated documents in the list of search results. For example, a score assigned to a category associated with a document with a higher score may be higher than a score assigned to a category associated with a document with a lower score. In some cases, it may be possible for the categories associated with two different documents to be assigned the same score, such as when the two documents have similar scores.

Category suggestion engine 420 may combine (e.g., add) the scores assigned to the categories. For example, a category may be associated with a number of documents in the list of search results. Category suggestion engine 420 may add the scores for the category to identify its final score. Category suggestion engine 420 may then identify the highest scoring one or more categories and present them as suggestions for the search with the list of search results.

According to another implementation, category suggestion engine 420 may count the number of occurrences of each of the categories. Category suggestion engine 420 may then assign a final score to the categories based on their number of occurrences. Category suggestion engine 420 may then identify the highest scoring one or more categories and present them as suggestions for the search with the list of search results.

Sometimes the categories are derived from a number of different category providers that may use different naming schemes. For example, a category for pizza restaurants may be named “pizza restaurant” under one naming scheme and “restaurant: pizza” under another naming scheme. In one implementation, category suggestion engine 420 may consider similar category names as the same category for scoring purposes. Also, category suggestion engine 420 may use the naming scheme associated with the highest scoring category when presenting category suggestions. In another implementation, category suggestion engine 420 may use a different technique.

Exemplary Processing

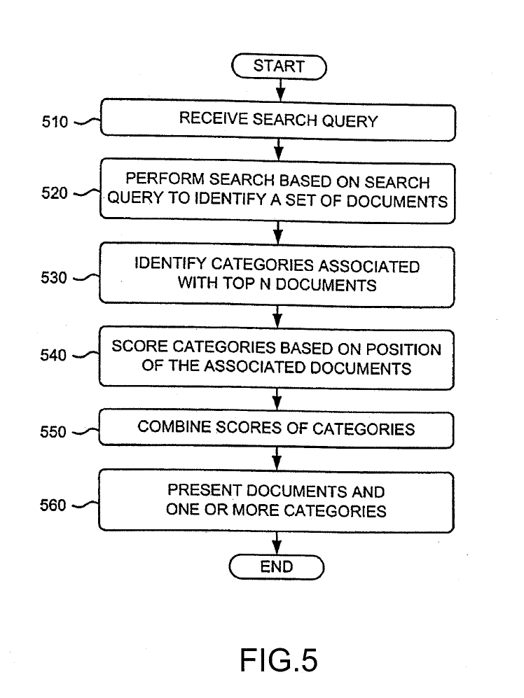

FIG. 5 is a flowchart of exemplary processing for presenting category suggestions relating to a search according to an implementation consistent with principles of the disclosure. Processing may begin with server 220 receiving a search query (block 510). In one implementation, a user may use a web browser associated with a client 210 to provide the search query to server 220.

A search may be performed to identify a set of documents based on the search query (block 520). For example, the term(s) of the search query may be compared to the text of documents in the document corpus. Documents related to the search query may be identified and scored in a manner similar to that described above.

Categories associated with the top N (e.g., 1000) documents in the list of search results may be identified (block 530). In one implementation, the categories may be identified by looking up category information in a database.

The categories may be scored based on the positions of the associated documents in the list of search results (block 540). For example, the category scores may, in one implementation, be based on the scores (which determine the position) of the associated documents in the list of search results. The scores for each of the categories may then be combined (e.g., added) to identify a final score assigned to the category (block 550). In another implementation, final scores may be assigned to the categories based on a count of the number of occurrences of the categories.

The one or more highest scoring categories may be presented as suggestions for the search along with the list of search results (block 560). The category suggestions may assist the user in refining the search query to find documents in which the user is interested. For example, if the user selects one of the category suggestions, a refined search may be performed to identify documents in the list of search results that are assigned to the category corresponding to the selected category suggestion. Alternatively, the documents in the list of search results may be replaced with documents associated with the selected category suggestion.

### Example

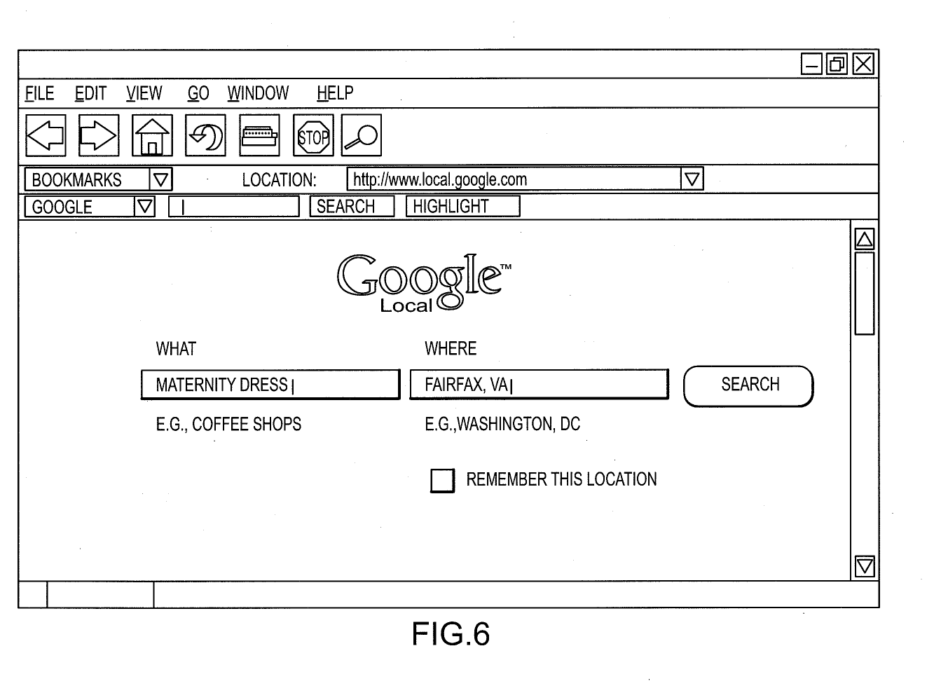

FIG. 6 is an exemplary diagram of a local search user interface that may be presented to a user according to an implementation consistent with principles of the disclosure. As shown in FIG. 6, a user interface may be presented relating to local searching. The local search user interface may permit a user to search for business listings in a particular location. To assist the user in searching, the user interface may provide a “What” field and a “Where” field. For example, the user may enter the name of a business (e.g., “Pizza Hut”) or a type of business (e.g., pizza restaurant) in the “What” field. The user may enter the name of a location (e.g., Albany, N.Y.) in the “Where” field. Assume for this example, that the user entered “maternity dress” in the What field and “Fairfax, Va.” in the Where field of the user interface.

A server associated with the local search user interface, such as server 220, may perform a search based on the search terms “maternity dress” and “Fairfax Va.” to identify documents associated with businesses relating to the search terms “maternity dress” in the “Fairfax, Va.” location and include the identified documents in a list of search results. As described above, categories may be identified for the documents, the categories may be scored, and the one or more highest scoring categories may be determined.

The local search user interface may present the list of search results. For each document in the list of the search results (or for some set of the search results), the user interface may provide address information for the business associated with the document, a telephone number for the business, a link to more information associated with the business, a link to directions to the business, and/or a link to one or more documents that refer to the business. The user interface may also provide a map of the area covered by the search. The map may optionally include pointers to businesses associated with the list of search results (or some set of the search results).

The local search user interface may present one or more category suggestions relating to the search. As explained above, the category suggestions may correspond to the one or more highest scoring categories. In one example, the category suggestions include a “Clothing Stores” category and a “Consignment & Resale Stores” category.

Assume that the user selected the clothing stores category. In this case, the server may refine the search to identify documents associated with businesses relating to the search terms “maternity dress” in the “Fairfax, Va.” location that are assigned to the clothing stores category and include the identified documents in a modified list of search results. Alternatively, the server may replace the user's search query with the selected category. In this case, the server may provide documents relating to the selected category as a modified list of search results.

The local search user interface may present the modified list of search results. For each document in the modified list of the search results (or for some set of the search results), the user interface may provide address information for the business associated with the document, a telephone number for the business, a link to more information associated with the business, a link to directions to the business, and/or a link to one or more other web documents that refer to the business. The user interface may also provide a map of the area covered by the search. The map may optionally include pointers to businesses associated with the list of search results (or some set of the search results).

Assume that the user selected the consignment & resale stores category. In this case, the server may refine the search to identify documents associated with businesses relating to the search terms “maternity dress” in the “Fairfax, Va.” location that are assigned to the consignment & resale stores category and include the identified documents in a modified list of search results. Alternatively, the server may replace the user's search query with the selected category. In this case, the server may provide documents relating to the selected category as a modified list of search results.

The local search user interface may present the modified list of search results. For each document in the modified list of the search results (or for some set of the search results), the user interface may provide address information for the business associated with the document, a telephone number for the business, a link to more information associated with the business, a link to directions to the business, and/or a link to one or more other web documents that refer to the business. The user interface may also provide a map of the area covered by the search. The map may optionally include pointers to businesses associated with the list of search results (or some set of the search results).

Systems and methods consistent with principles of the disclosure may perform a search to identify documents based on a search query and use information regarding the categories to which the documents are assigned to suggest categories that relate to the search. The categories may be used to further define or replace the search and present a user with results that are relevant to the user's interests.

Cloaking of Search Parameters and User Information

Social networks, dating sites, and e-commerce sites on computer networks such as the Internet often allow users to create profile pages that reveal personal information about the users to others connected to those sites' networks or even to the general public. A user may search for another user, product, or service in a database based on matched criteria in search queries.

Using Internet dating sites as a example, a first user may search on several search parameters in a query, such as “woman, brown hair.” As used herein, the term “search parameter” means any of various components used to develop a search query, including any or all of a group of one or more words, any or all of a group of one or more tags, any or all of a group of one or more categories of items, and/or any or all of a group of one or more specifications by the user or an administrator to include or exclude one or more items, search terms, or search results.

The matching of a second user's query with a first user's query, in at least some respects or as to at least some search parameters, may be termed a “match.”

If second user's query matching the first user's query is found, this matching information is generally provided to both the first and second users. The first user can generally see all the parameters specified by the second user (such as “man, blonde hair”) and the second user can generally see all the parameters specified by the first user (“woman, brown hair”).

While this sort of mutual information sharing can be beneficial, at times the first user may wish to keep certain search parameters hidden, or cloaked, from at least the second user (and possibly from the entire world), at least until, for example, the first user obtains more information about the matched search. If he can learn more about, e.g., the second user's location or one or more of her characteristics, he may then have an opportunity to decide whether to reveal the hidden information in his query to the second user and possibly to others.

For instance, the first user may want the second user to know, if a match occurs, that he searched on the parameter “woman,” but he may not want her to know he searched on “brown hair.” In some aspects of the disclosure, the first user could specify that the search term “brown hair” is hidden, or cloaked, from his search, while “woman” is a non-hidden, or uncloaked, term in his search. In some aspects of the disclosure, the first user could specify that the term “brown hair,” or other search term or user specification, is hidden from visibility on one or more of his user profile pages associated with the site on which his searching or matching may be conducted.

Like the first user, the second user may choose to keep any, all, or none of her search parameters non-hidden (uncloaked) or hidden from her search. In this case, she may select to keep both terms “man” and “blonde hair” uncloaked, and thus visible to the first user, assuming a match is made through an association between the first and second users' search queries. This choice may also allow others who match her search query to see any or all of her relevant uncloaked search parameters.

Designating a portion of a search query as non-hidden status includes at least either or both of (1) affirmatively assigning a non-hidden (open or uncloaked) status to the portion, and (2) not assigning a hidden (closed or cloaked) status to the portion. In other words, a user can designate a portion of a query as non-hidden either actively or passively (i.e., through taking no action), or both.

Designating a portion of a search query as hidden status (which also may be called “closed,” “cloaked,” “confidential,” or the like) refers to hiding, or not revealing, at least temporarily, the portion to at least one other user, including a person or robot operating a client device, or a network device, such as a server administrator.

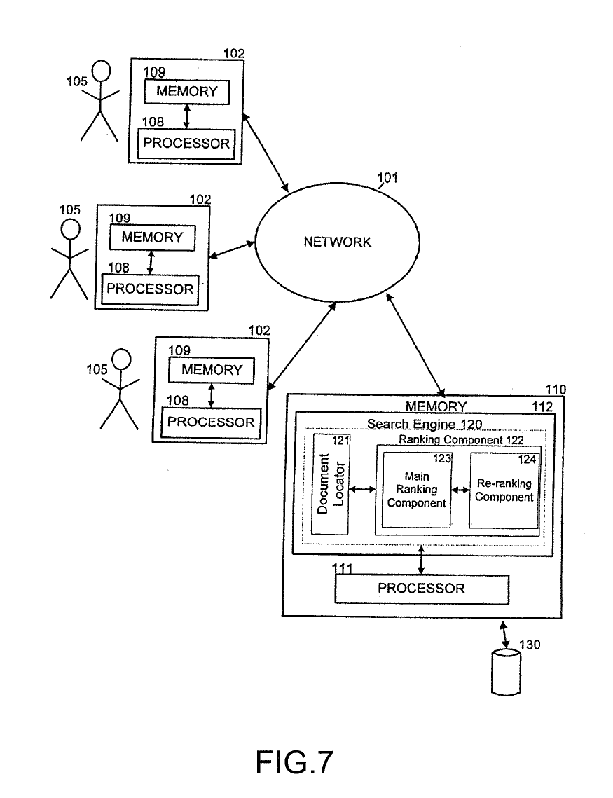

FIG. 7 is a diagram illustrating an exemplary system in which concepts consistent with the present inventions may be implemented. The system includes multiple client devices 102, a server device 110, and a network 101, which may be, for example, the Internet. Client devices 102 each include a computer-readable medium 109, such as random access memory, coupled to a processor 108. Processor 108 executes program instructions stored in memory 109. Client devices 102 may also include a number of additional external or internal devices, such as, without limitation, a mouse, a CD-ROM, a keyboard, and a display.

Through client devices 102, users 105 can communicate over network 101 with each other and with other systems and devices coupled to network 101, such as server device 110.

Similar to client devices 102, server device 110 may include a processor 111 coupled to a computer readable memory 112. Server device 110 may additionally include a secondary storage element, such as database 130.

Client processors 108 and server processor 111 can be any of a number of well known computer processors, such as processors from Intel Corporation, of Santa Clara, Calif. In general, client device 102 may be any type of computing platform connected to a network and that interacts with application programs, such as a digital assistant or a “smart” cellular telephone or pager. Server 110, although depicted as a single computer system, may be implemented as a network of computer processors.

Memory 112 contains a search engine program 120. Search engine program 120 locates relevant information in response to search queries from users 105. In particular, users 105 send search queries to server device 110, which responds by returning a list of relevant information to the user 105. Typically, users 105 ask server device 110 to locate web pages relating to a particular topic and stored at other devices or systems connected to network 101. Search engine 120 includes document locator 121 and a ranking component 122. In general, document locator 121 finds a set of documents whose contents match a user search query. Ranking component 122 further ranks the located set of documents based on relevance. A more detailed description of the functionality implemented by search engine 120, document locator 121, and ranking component 122 will be described below.

Document locator 121 may initially locate documents from a document corpus stored in database 130 by comparing the terms in the user's search query to the documents in the corpus. In general, processes for indexing web documents and searching the indexed corpus of web documents to return a set of documents containing the searched terms are well known in the art. Accordingly, this functionality of relevant document component 121 will not be described further herein.

Ranking component 122 assists search engine 120 in returning relevant documents to the user by ranking the set of documents identified by document locator 121. This ranking may take the form of assigning a numerical value corresponding to the calculated relevance of each document identified by document locator 121. Ranking component 122 includes main ranking component 123 and re-ranking component 124. Main ranking component 123 assigns an initial rank to each document received from document locator 121. The initial rank value corresponds to a calculated relevance of the document. There are a number of ranking algorithms known in the art, one of which is described in the article by Brin and Page, as mentioned above. Alternatively, the functions of main ranking component 123 and document locator 121 may be combined so that document locator 121 produces a set of relevant documents each having rank values. In this situation, the rank values may be generated based on the relative position of the user's search terms in the returned documents. For example, documents may have their rank value based on the proximity of the search terms in the document (documents with the search terms close together are given higher rank values) or on the number of occurrences of the search term (e.g., a document that repeatedly uses a search term is given a higher rank value).

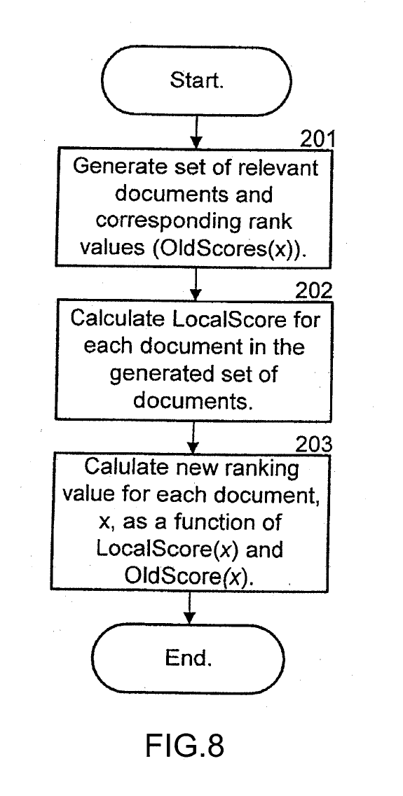

FIG. 8 is a flow chart illustrating methods consistent with the present inventions for implementing ranking component 122.

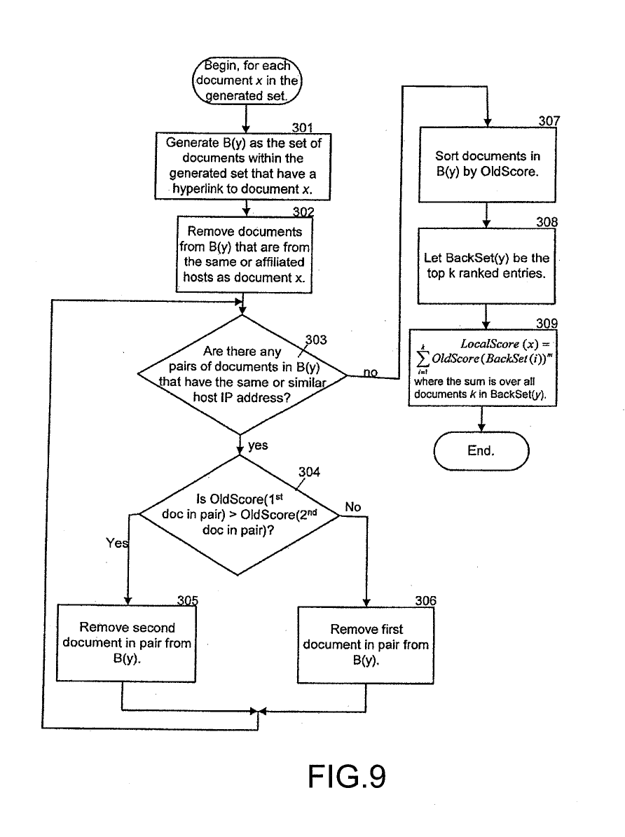

In response to a search query, document locator 121 and main ranking component 123 generate an initial set of relevant documents, including ranking values associated with each of the documents in the set. (Act 201). This initial set of documents may optionally be limited to a preset number N (e.g., N=1000) of the most highly ranked documents returned by main ranking component 123. The initial rankings, for each document, x, in the returned set of relevant documents, is referred to herein as OldScores(x). For each document in the set, re-ranking component 124 calculates a second value, referred to as LocalScore(x). (Act 202). The LocalScore for each document x is based on the relative support for that document from other documents in the initial set (the computation of LocalScore is described in more detail below with reference to FIG. 9). Documents linked to by a large number of other documents in the initial set (i.e., documents with high relative support), will have a high LocalScore. Finally, search engine 120 computes the final, new ranking value for each document, called NewScore(x), as a function of the document's LocalScore value and its OldScore value. (Act 203).

FIG. 9 is a flow chart illustrating the calculation of the LocalScore value, by re-ranking component 124, for each document x in the initial set of documents.

Re-ranking component 122 begins by identifying the documents in the initial set that have a hyperlink to document x. (Act 301). The set of documents that have such hyperlinks are denoted as B(y). Documents from the same host as document x tend to be similar to document x but often do not provide significant new information to the user. Accordingly, re-ranking component 124 removes documents from B(y) that have the same host as document x. (Act 302). More specifically, let IP3(x) denote the first three octets of the IP (Internet Protocol) address of document x (i.e., the IP subnet). If IP3(x)=IP3(y), document y is removed from B(y).

On occasion, multiple different hosts may be similar enough to one another to be considered the same host for purposes of Acts 301 and 302. For example, one host may be a “mirror” site for a different primary host and thus contain the same documents as the primary host. Additionally, a host site may be affiliated with another site, and thus contain the same or nearly the same documents. Similar or affiliated hosts may be determined through a manual search or by an automated web search that compares the contents at different hosts. Documents from such similar or affiliated hosts may be removed by re-ranking component 124 from B(y) in Act 302.

Re-ranking component 124 next compares all pairs of documents in B(y) for any pair in which IP3(first document of the pair)=IP3(second document of the pair), and removes the document of the pair from B(y) that has the lower OldScore value. (Acts 303-306). In other words, if there are multiple documents in B(y) for the same (or similar or affiliated) host IP address, only the document most relevant to the user's search query, as determined by the document's OldScore, is kept in B(y). Documents are removed from B(y) in this manner to prevent any single author of web content from having too much of an impact on the ranking value.

After removing documents from B(y) in Acts 303-306, re-ranking component 124 sorts the documents in B(y) based on OldScore(y). (Act 307). Let BackSet(y) be the top k entries in the sorted version of B(y), (Act 308), where k is set to a predetermined number (e.g., 20). Re-ranking component 124 then computes LocalScore(x) as shown in U.S. Pat. No. 6,526,440 (assigned to Google), col.4, ll.56-58, where the sum is over the k documents in BackSet and m is a predetermined value that controls the sensitivity of LocalScore to the documents in BackSet. (Act 309). The appropriate value at which m should be set varies based on the nature of the OldScore values, and can be determined by trial and error type testing. Typical values for m are, for example, one through three.

As previously mentioned, the final re-ranking value, NewScore, is computed for each document x by search engine 120 as a function of LocalScore(x) and OldScore(x). More particularly, NewScore(x) may be defined as where MaxLS is the maximum of the LocalScore values and MaxOS is the maximum of the OldScore values for each document in the initial set of documents. The a and b values are constants, and, may be, for example, each equal to one.

Occasionally, a set of documents may have very little inter-connectivity. In this situation, MaxLS will be low. However, because of the lack of inter-connectivity, the contribution of LocalScore to the NewScore value should be reduced. Accordingly, re-ranking component 124 may set MaxLS to a higher value when MaxLS is below a preset threshold. Stated more formally, if MaxLS is less than MaxLSMin, then MaxLS is set to MaxLSMin, where MaxLSMin is a predetermined minimum value. The appropriate value for MaxLSMin is dependent on the nature of the ranking values generated by main ranking component 123 and can be determined by trial and error.

As described above, a document's relevance ranking, as determined by a conventional document ranking component, is refined based on the inter-connectivity between the document and other documents that were initially determined to be relevant to a user's search query. The new, modified rank value for the document may then be used by the search engine in ordering the list of relevant documents returned to the user.

In operation, search engine 120 may receive a search query from one of users 105. Document locator 121 generates an initial list of potentially relevant documents. These documents are ranked by main ranking component 123 based on relevance, and then assigned modified rank values by re-ranking component 124. Search engine 120 may then sort the final list of documents based on the modified rank values (i.e., on the NewScore values) and return the sorted list to the user. Ideally, the documents that the user is most interested in viewing will be the first ones returned by search engine 120.

Crawling, Indexing, and Ranking Objects in a Network

Embodiments of the disclosure relate further to improved techniques for analyzing large directed graphs for use in computer systems, and in particular to reducing the computational complexity of assigning ranks to nodes.

The following discussion concerns some embodiments of search engine environments where the linked database is generated from crawling a number of documents, such as the Internet. This discussion tracks the illustrated description of such an environment in U.S. Pat. No. 7,028,029 (assigned to Google), the entirety of which is incorporated herein by reference.

A search engine has a back end system and a front end system. The layout of the search engine system is merely exemplary and can take on any other suitable layout or configuration. The back end system may include one or more crawlers (also known as spiders), one or more document indexers and a document index. To index the large number of Web pages that exist on the worldwide web, the web crawler locates and downloads web pages and other information (hereinafter also referred to as “documents”). In some embodiments, a set of content filters identify and filter out duplicate documents, and determine which documents should be sent to the document indexers for indexing. The document indexers process the downloaded documents, creating a document index of terms found in those documents. If a document changes, then the document index is updated with new information. Until a document is indexed, it is generally not available to users of the search engine.

The front end may include a web server, one or more controllers, a cache, a second level controller and one or more document index servers 1, 2, . . . n. The document index is created by the search engine and is used to identify documents that contain one or more terms in a search query. To search for documents on a particular subject, a user enters or otherwise specifies a search query, which includes one or more terms and operators (e.g., Boolean operators, positional operators, parentheses, etc.), and submits the search query to the search engine using the web server.

The controller is coupled to the web server and the cache. The cache is used to speed up searches by temporarily storing previously located search results. In some embodiments, the cache is distributed over multiple cache servers. Furthermore, in some embodiments, the data (search results) in the cache is replicated in a parallel set of cache servers.

While the following discussion describes certain functions as being performed by one or more second level controllers, it should be understood that the number of controllers and the distribution of functions among those controllers may vary from one implementation to another. The second level controller communicates with one or more document index servers. The document index servers (or alternately, one of the controllers) encode the search query into an expression that is used to search the document index to identify documents that contain the terms specified by the search query. In some embodiments, the document index servers search respective partitions of the document index generated by the back end system and return their results to the second level controller. The second level controller combines the search results received from the document index servers, removes duplicate results (if any), and forwards those results to the controller.

In some embodiments, there are multiple second level controllers that operate in parallel to search different partitions of the document index, each second level controller having a respective set of document index servers to search respective sub-partitions of document index. In such embodiments, the controller distributes the search query to the multiple second level controllers and combines search results received from the second level controllers. The controller also stores the search query and search results in the cache, and passes the search results to the web server. A list of documents that satisfy the search query is presented to the user via the web server.

In some embodiments, the content filters, or an associated set of servers or processes, identify all the links in every web page produced by the crawlers and store information about those links in a set of link records. The link records indicate both the source URL and the target URL of each link, and may optionally contain other information as well, such as the “anchor text” associated with the link. A URL Resolver reads the link records and generates a database 128 of links, also called link maps, which include pairs of URLs or other web page document identifiers. In some embodiments, the links database is used by a set of one or more Page Rankers to compute Page Ranks for all the documents downloaded by the crawlers. These Page Ranks are then used by the controller to rank the documents returned in response to a query of the document index by document index servers. Alternately, the document index servers may utilize the Page Ranks when computing query scores for documents listed in the search results. In certain embodiments of the present inventions, the back end system further comprises quantizers that are used to quantize data in Page Ranks. Brin and Page, “The Anatomy of a Large-Scale Hypertextual Search Engine,” 7th International World Wide Web Conference, Brisbane, Australia, provides more details on how one type of Page Rank metric can be computed. Other types of link-based on non-link based ranking techniques could also be utilized.

A link-based ranking system, such as PageRank, makes the assumption that a link from a page u to a page v can be viewed as evidence that page v is an “important” page. In particular, the amount of importance conferred on page v by page u is proportional to the importance of page u and inversely proportional to the number of pages to which page u points. Since the importance of page u is itself not known, determining the importance for every page i requires an iterative fixed-point computation.

In some embodiments, the importance of a page i is defined as the probability that at some particular time step, a random web surfer is at page i. Provided that the surfer chooses one of the links on page i, that link is chosen with a probability of 1 divided by the number of outlinks from page i, when the probability of choosing any of the outlinks is uniform across the outlinks. A transition probability matrix, P, may be created where P(i,j) is provided as 1/deg(i), where deg(i) represents the number of outlinks from page i. In other embodiments, P(i,j) could take into consideration certain personalization information for an individual or for a group, or could take into account other information derived from page i itself and/or elsewhere, and need not be uniform over each outlink from a given page.

Some web pages have no outlinks, but for P to be a more useful transition probability matrix, every node must have at least 1 outgoing transition, i.e., P should have no rows consisting of all zeros. A matrix P can be converted into a more useful transition matrix by adding a complete set of outgoing transitions to pages with outdegree(0), i.e., no outlinks, to account for the probability that the surfer visiting that page randomly jumps to another page. In one embodiment, the row for a page having no outlinks is modified to account for a probability that the surfer will jump to a different page uniformly across all pages, i.e., each element in the row becomes 1/n, where n is the number of nodes, or pages. In another embodiment, the modification could be non-uniform across all nodes and take into account personalization information. This personalization information might cause certain pages to have a higher probability compared to others based on a surfer's preferences, surfing habits, or other information. For example, if a surfer frequently visits http://www.google.com, the transition probability from page i to the Google homepage would be higher than a page that the user infrequently visits. Another modification to P may take into account the probability that any random surfer will jump to a random Web page (rather than following an outlink). The destination of the random jump is chosen according to certain probability distributions. In some embodiments, this is uniform across all pages and in some embodiments this distribution is non-uniform and based on certain personalization information. Taking the transpose of the twice modified matrix P provides a matrix A. In the matrix P, a row i provided the transition probability distribution for a surfer at node i, whereas in the matrix A this is provided by column i. Mathematically this can be represented as: A=(c(P+D)+(1−c)E).sup.T, where P is a probability transition where P(i,j) represents the probability that the surfer will choose one of the links on i to page j; D represents the probability that a surfer visiting a page with no outlinks will jump to any other page; E represents the probability that a surfer will not choose any of the links and will jump to another page; and (1−c) represents a de-coupling factor indicating how likely it is that a surfer will jump to a random Web page, while c represents a coupling factor indicating how likely it is that a surfer will select one of the links in a currently selected or viewed page.

Assuming that the probability distribution over all the nodes of the surfer's location at time 0 is given by x.sup.(0), then the probability distribution for the surfer's location at time k is given by x.sup.(k)=A.sup.(k)x.sup.(0). The unique stationary distribution of the Markov chain is defined as lim.sub.k.fwdarw..infin.x.sup.(k), which is equivalent to lim.sub.k.fwdarw..infin.A.sup.(k)x.sup.(0), and is independent of the initial distribution x.sup.(0). This is simply the principal eigenvector of the matrix A and the values can be used as ranking values. One way to calculate the principal eigenvector begins with a uniform distribution x.sup.(0)=v and computes successive iterations of the ranking function, x.sup.(k)=A x.sup.(k−1), until convergence. Convergence can be defined when two successive iterations of the ranking function produce a difference within a tolerance value. Various method can be used to determine tolerance values based on desired convergence characteristics or how much variation exists as the tolerance decreases.

An exemplary cumulate plot of convergence times uses the above described iterative process. The x-axis represents convergence by iteration number and the y-axis represents the cumulative proportion of document rank values that have converged. At a point, it can be seen, for an exemplary data set, that a large number of ranks have converged by the point within 20 iterations, but the final ranks take a significantly longer time to converge.

Embodiments of the invention take advantage of this skewed distribution of convergence times to reduce the computational cost required for the determination of the full set of document rank values. Computational cost can be reduced by reducing the number of operations that must be performed and/or simplifying the types that must be preformed. Additionally, reducing the need to move items in and out of main memory can have an effect on computational cost. By not recalculating the ranks of those ranks which have converged during a particular cycle of iterations, embodiments of the invention reduce the computation cost of determining document rank values.

A directed graph of linked documents is initially created where each document is represented by a node in the graph, and all nodes are associated with the set of nodes whose document rank values have not converged. If the set of nodes which have not converged is empty, then all the nodes have converged and the process ends. If the set of nodes which have not converged is not empty, then an iteration of the function is calculated for those nodes which have not converged. A predetermined number of iterations are completed per given cycle before examining which nodes' document rank values have converged. Accordingly, if a predetermined number of iterations for the current cycle has not been completed, then an additional iteration is calculated.

On the other hand, if the predetermined number of iterations for the cycle been completed, then those nodes whose ranks have converged are identified. The number of iterations per cycle can be chosen in different ways and in some embodiments may depend on the balancing the computation cost of identifying the nodes which have converged and modifying the ranking function versus computing the iterations. For example, the number of iterations could be chosen from a number between 5 and 15. In other embodiments, the number of iterations prior to identifying converged ranks could vary depending on a given cycle, with successive cycles having different number of iterations. For example, when the number of iterations for a cycle has been met, the number of iterations for the next loop could be modified, such that the next iterative cycle would end after a different set of iterations, and so on. In other embodiments, instead of basing the end of a cycle on whether a number of iterations have been completed, the cycle is based on a proportion of nodes whose rank has converged. For example, the first cycle of iterations could complete after 25% of the nodes have converged. The proportion for the next cycle could be set to be an additional 25% or some other percentage. One of ordinary skill in the art will readily recognize other ways this concept can be expanded using various criteria to end the iterative cycle.

After the iteration cycle is complete, those nodes whose document ranking value has converged to within a predefined iteration tolerance are identified. In some embodiments, the same tolerance value is used for each cycle of iteration and in other embodiments, the tolerance value could vary depending on the iterative cycle. Tolerances values could be selected from 0.00001 to 0.01, or other values. Those nodes which have converged are disassociated with the set of non-converged nodes. The process continues until all document rank values have converged or some other type of ending mechanism is triggered. Other triggering mechanisms might include, for example, identifying convergence for a specific subset of nodes.

In other embodiments, a first phase of rank computation may be computed using an initial tolerance level for convergence as described above and using the phase tolerance level for each cycle of iteration in the phase. However, another phase of rank computation could follow using a second tolerance level for the cycles in the phase and using the ranks previously computed in the first phase as respective, initial document rank values in the next phase of rank computation. In some embodiments, the second tolerance level is smaller by an order of magnitude than the previous phase. In some embodiments, more than two phases are used with successively narrower tolerances for convergence.

When the nodes whose document rank values are associated with the converged set, their document rank values are no longer calculated. In some embodiments, computing only document rank values which have not converged takes advantage of the matrix structure of the ranking function. As mentioned above, in some embodiments, the ranking function can be described as x.sup.(k)=A x.sup.(k−1). At some time k, some of the document rank values will have converged. A ranking function can describe where some of the rank values have converged. The document rank value at the k+1.sup.st iteration of the ranking function for node, or document, i, x.sub.i.sup.(k+1). The document ranking values for the k+1.sup.st iteration are given by the matrix multiplication of A by the k.sup.th iteration of the document rank values x.sub.i.sup.(k). The ranks which have converged by iteration k can be represented by x.sub.n-m+1.sup.(k) to x.sub.n.sup.(k), where n represents the total number of nodes, or documents, and m represents the number of document rank values which have converged.

Accordingly, the values for x.sub.n-m+1.sup.(k+1) to x.sub.n.sup.(k+1) at the k+1.sup.st iteration will be the same as x.sub.n-m+1.sup.(k) to x.sub.n.sup.(k) and those document rank values need not be calculated again. In some embodiments, only the calculations for those nodes which have not converged are calculated. The ranking function is modified to remove those rows from the calculation. In some embodiments, the rows and/or columns of the matrix corresponding to the converged nodes are not read into memory. In some embodiments, the matrix multiplication needed for rows corresponding to the converged ranks are simply ignored and not calculated. In other embodiments the rows corresponding to the converged ranks are replaced by all zeros (which significantly reduces computation time). In these embodiments, the column is not affected since the converged values therein are used in the ranking function iteration. In some embodiments, the rows are initially ordered by decreasing order of convergence based on a previous solving of the ranking function. This has the effect of keeping longer converging nodes in main memory and reducing the amount of memory accesses to read portions of the modified ranking function into memory during the course of the computation. As mentioned earlier, reducing the amount of memory accesses can significantly reduce computation cost.

During each cycle of iteration, the contributions to the rank of a non-converged node from the converged nodes is a constant. Accordingly, in some embodiments these contributions are only calculated once per cycle of iteration. After a period of iterations, the nodes have converged as described above. Accordingly, the values will remain constant throughout each iteration cycle until another examination of convergence is made. The matrix now may be thought of as consisting of 4 partitions. The partition illustrates the contributions that the non-converged nodes make to other non-converged nodes (also called a sub-matrix). A partition can illustrate the contributions that converged nodes make to converged nodes. Another partition can illustrate the contributions that the non-converged nodes make to the converged nodes. Finally, a third partition can illustrate the contributions that the converged nodes make to the non-converged nodes. When the first matrix (the previous document ranks values) is multiplied against a row i in the second matrix, the multiplication products corresponding to values in partition 514 are constants. Therefore, to modify the ranking function even further, some embodiments only calculate the products produced by multiplying a partition (representing contributions of the converged nodes to the non-converged nodes) once per iteration cycle. The sum of those products is a constant for each row of two partitions. This constant for each row is used each time a new iteration is computed. If one partition is represented as A.sub.NN; another partition is represented as A.sub.CN; the non-converged nodes sub-matrix is represented by x.sub.N.sup.(k+1) and the converged nodes sub-matrix is represented by x.sub.C.sup.(k), then the modified ranking function is represented as x.sub.N.sup.(k+1)=A.sub.NN x.sub.N.sup.(k)+A.sub.CN x.sub.C.sup.(k). The last term in the modified ranking function, A.sub.CN x.sub.C.sup.(k), produces a matrix of constants that may be computed once and then reused during subsequent computational iterations.

Although some of the drawings illustrate a number of logical stages in a particular order, stages which are not order dependent may be reordered and other stages may be combined or broken out. While some reordering or other groupings are specifically mentioned, others will be obvious to those of ordinary skill in the art and so do not present an exhaustive list of alternatives. Moreover, it should be recognized that the stages could be implemented in hardware, firmware, software or any combination thereof.

An embodiment of a computer that implements the methods described above includes one or more processing units (CPU's), one or more network or other communications interfaces, memory, and one or more communication buses for interconnecting these components. The computer may optionally include a user interface comprising a display device (e.g., for displaying system status information) and/or a keyboard (e.g., for entering commands). Memory may include high speed random access memory and may also include non-volatile memory, such as one or more magnetic or optical storage disks. Memory may include mass storage that is remotely located from CPU's. The memory may store: an operating system that includes procedures for handling various basic system services and for performing hardware dependent tasks; a network communication module (or instructions) that is used for connecting the computer to other computers via the one or more communications network interfaces (wired or wireless), such as the Internet, other wide area networks, local area networks, metropolitan area networks, and so on; a page ranker for computing page ranks as described above and includes: a computation module for computing iterations of a ranking function as described above; a modification module that modifies the ranking function to reduce the ranking function's computation cost as described above including a removal module for removing rows from the ranking functions as described above and/or a modifier module for modifying the ranking function based on the identified converged nodes as described above; an identification module for identifying those nodes that have converged; and a convergence module for determining when a nodes has converged.

Each of the above identified modules corresponds to a set of instructions for performing a function described above. These modules (i.e., sets of instructions) need not be implemented as separate software programs, procedures or modules, and thus various subsets of these modules may be combined or otherwise re-arranged in various embodiments.

Have, Want, and Think designations for categorized cross-searching

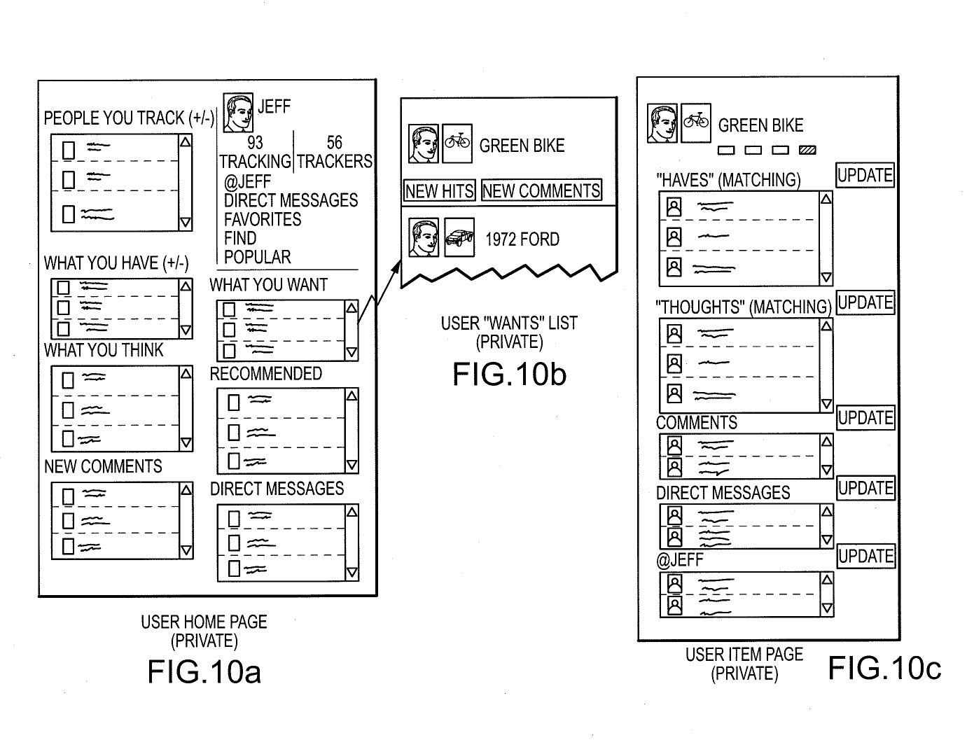

FIG. 10a illustrates an embodiment of a user region of a computer network-based (e.g., web-based) system, or user home page. The home page has regions designated for input by the user describing and/or listing items representing at least one of (a) one or more things the user has (“haves”), (b) one or more things the user wants (“wants”), and (c) one or more things about which the user is thinking, or has thought (“thoughts”). The user home page is private, meaning its visibility or accessibility is restricted to persons designated by the user, and it is not generally viewable to the public on the computer network.

Items the use “has” can include, for example, at least one of: (a) a skill of the user, as specified by the user; (b) an item possessed by the user, as specified by the user; (c) an item rented by the user, as specified by the user; (d) a service provided by the user, as specified by the user; (e) a characteristic of the user, as specified by the user; and (f) a person known and/or related to the user, as specified by the user.

Items the use “wants” can include, for example, at least one of: (a) an item the user desires to acquire, as specified by the user; (b) an item the user desires to rent, as specified by the user; (b) a specification of potential travel by the user, as specified by the user; (c) a nonmonetary aspiration of the user, as specified by the user; and (d) a person and/or a characteristic of a person the user desires to meet or engage in a relationship, as specified by the user.

Items the user “thinks” (i.e., about which the user is thinking, or has thought) can include, for example, at least one of: (a) a concept the user is considering, as specified by the user; (b) an item and/or person about which the user has learned, as specified by the user; (b) a statement about a past activity and/or future activity of the user and/or another person, as specified by the user; and (c) a commentary and/or critique by the user.

FIG. 10b illustrates an embodiment of a listing of “wants” visible on, or accessible from, the user home page. Visible flags such as “new hits” and “new comments” may alert the user to the existence of matching search results and comments by other users, respectively, for a given item. The same can exist for listings of “haves” and “thoughts.”

FIG. 10c illustrates an embodiment of a user item page, in this case showing a “want” item, a green bicycle. The user item page can include, without limitation, matching “haves” from other users, matching “thoughts” from other users, comments, direct messages or and/or emails, instant messages, and @name entries similar to that found on Twitter.com, i.e., posts from other users directed to the primary user, which posts may be visible on the other users' public profile pages.

The user item page shows an item that user Jeff “wants,” namely the green bicycle. Under the “green bike” designation in FIG. 10c are four rectangles, representing tags, search terms, and/or categories associated with the item. Using tags as an example, note that three tags on the left are “open,” or “visible,” or “non-hidden” (shown as non-stippled), and the tag on the right is “closed,” or “hidden,” or “cloaked” (shown as stippled). The cloaked tags are ones the user has chosen to hide, or cloak, from the public item page or public user profile page. These cloaked tags, together with uncloaked tags that may also be visible on the corresponding item profile page for the green bike, are used in a search that matches the item with associated objects entered by other users, such as “haves” or “thoughts.” The cloaked tags can be made visible only to the user, if he or she chooses, such as on the user home page.

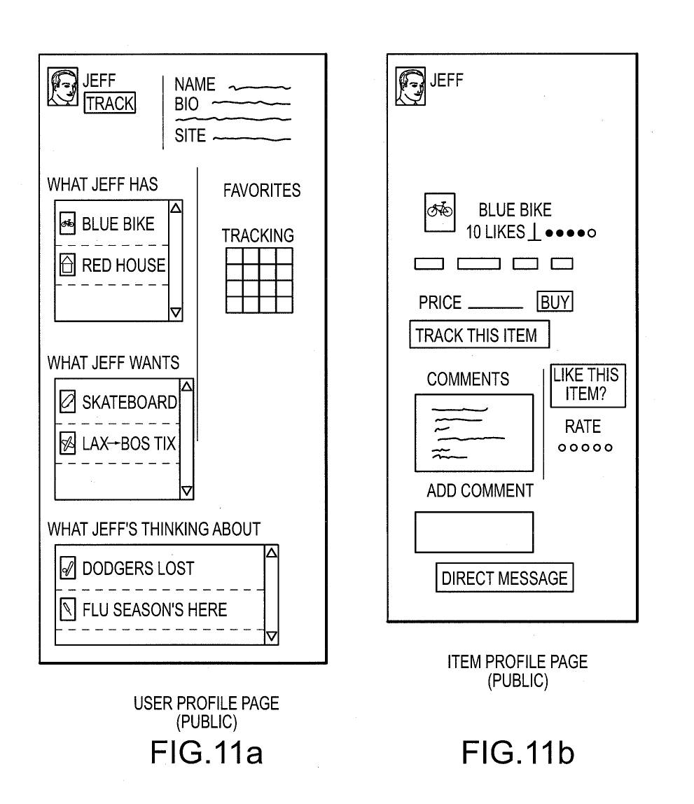

FIG. 11a illustrates an embodiment of a user profile page, which in this case is publicly visible to other users on the network, such as Internet users of the system who can view the user profile page in a web browser. The user profile page shows what user Jeff “has,” “wants,” and “thinks.”

FIG. 11b illustrates an embodiment of an item profile page, which in this case is publicly visible to other users on the network, such as Internet users of the system who can view the user item profile page in a web browser by, for example, clicking on a representational link for the item on the user profile page. The item profile page shows an item that user Jeff “has,” namely a blue bicycle. Under the “blue bike” designation in FIG. 11b are four rectangles, representing tags, search terms, and/or categories associated with the item. Using tags as an example, note that these are tags the user Jeff has chosen not to hide, or cloak, from the public item page or public user profile page. Other tags can be cloaked and associated with the blue bicycle, and these cloaked tags, together with the uncloaked tags visible on the item profile page, are used in a search that matches the item with associated objects (e.g., search terms, keywords, tags, and/or categories) entered by other users, such as “wants” or “thoughts.” The cloaked tags can be made visible only to the user, if he or she chooses, such as on the user home page.

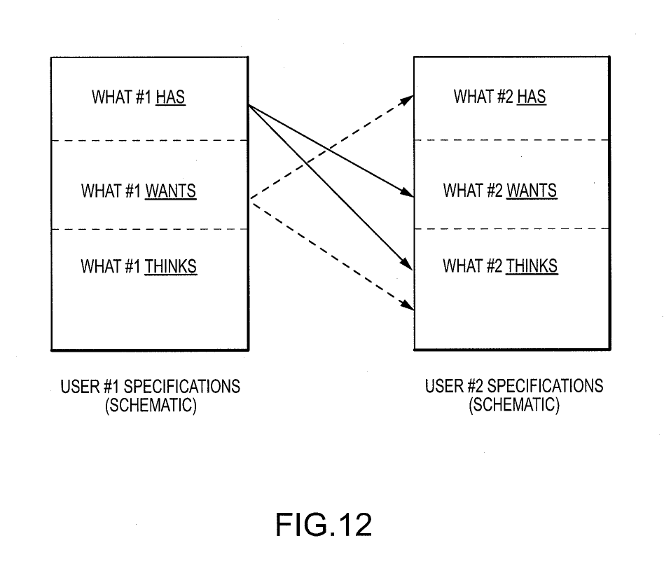

FIG. 12 is a schematic view of an embodiment of cross-searching, or matching, among users “haves,” “wants,” and “thoughts.” In the embodiment, a first user's “have” (what she “has”) can be matched with, or searched against, what a second user, or group of users, “want” (what they “want”). The first user's “have” (what she “has”) can also be matched with, or searched against, what the second user, or group of users, “thinks” (e.g., what they are thinking about or have thought about, embodied, for example, as comments).

FIG. 12 also shows that the first user's “want” (what she “wants”) can be matched with, or searched against, what a second user, or group of users, “has” (what they “have”). The first user's “want” (what she “wants”) can also be matched with, or searched against, what the second user, or group of users, “thinks” (e.g., what they are thinking about or have thought about, embodied, for example, as comments).

This matching or searching can occur in ways known to those of skill in the art, including, for example, searching indexed databases as described in any one or more of the. U.S. patent references incorporated herein by reference. Searching can produce matching “hits” (i.e., documents or objects relevant to the search) according to criteria such as recentness of posted information, user popularity, user ranking, links into or out of a user's profile page, category closeness, price, date, number of matching search terms and/or tags, relevance and/or importance of matched search terms and/or tags, and other criteria known to those of skill in the art and described in any one of more of the U.S. patent references incorporated herein by reference.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

The foregoing description of preferred embodiments of the present inventions provides illustration and description, but is not intended to be exhaustive or to limit the invention to the precise form disclosed. Modifications and variations are possible in light of the above teachings or may be acquired from practice of the invention.

For example, while a series of acts has been described with regard to FIG. 5, the order of the acts may be modified in other implementations consistent with principles of the disclosure. Further, non-dependent acts may be performed in parallel.

Also, exemplary user interfaces have been described with respect to FIGS. 6-9. In other implementations consistent with principles of the disclosure, the user interfaces may include more, fewer, or different pieces of information.

Category suggestions have been described as relating to the search. One skilled in the are would readily recognize that category suggestions also relate to interests of the user who provided the search query.

Further, certain portions of the invention have been described as an “engine” that performs one or more functions. An engine may include hardware, such as an application specific integrated circuit or a field programmable gate array, software, or a combination of hardware and software.

It will be apparent to one of ordinary skill in the art that aspects of the invention, as described above, may be implemented in many different forms of software, firmware, and hardware in the implementations illustrated in the figures. The actual software code or specialized control hardware used to implement aspects consistent with principles of the disclosure is not limiting of the invention. Thus, the operation and behavior of the aspects were described without reference to the specific software code, it being understood that one of ordinary skill in the art would be able to design software and control hardware to implement the aspects based on the description herein.

No element, act, or instruction used in the present application should be construed as critical or essential to the invention unless explicitly described as such. The “aspects” and “embodiments” mentioned herein do not constitute the entirely of any of the inventions disclosed or claimed herein, but refer to subsets or features thereof. Also, as used herein, the article “a” is intended to include one or more items. Where only one item is intended, the term “one” or similar language is used. Further, the phrase “based on” is intended to mean “based, at least in part, on” unless explicitly stated otherwise.

The foregoing description of preferred embodiments of the present inventions provides illustration and description, but is not intended to be exhaustive or to limit the invention to the precise form disclosed. Modifications and variations are possible in light of the above teachings or may be acquired from practice of the invention. For example, although the preceding description generally discussed the operation of search engine in the context of a search of documents on the world wide web, a search engine could be implemented on any corpus. Moreover, while series of acts have been presented, the order of the acts may be different in other implementations consistent with the present inventions.

The scope of the invention is limited only by the claims and their equivalents.

What is claimed is:

1. A computer-implemented method, comprising:
in a computer network system, providing a first user page region;
providing in the first user page region an indicator of an identity of a primary user that is (i) input by the primary user, and (ii) viewable by the primary user and by a first set of persons comprising at least one person other than the primary user;
wherein the primary user and the at least one person other than the primary user are separated from each other at locations on a network in the system;
providing in the first user page region a first indicator, of at least one member of a first group of parameters, the first indicator determined by input by the primary user, and the members of the first group of parameters consisting of: (a) a skill of the primary user, as specified by the primary user; (b) an item possessed by the primary user, as specified by the primary user; (c) an item rented by the primary user, as specified by the primary user; (d) a service provided by the primary user, as specified by the primary user; (e) a characteristic of the primary user, as specified by the primary user; and (f) a person known and/or related to the primary user, as specified by the primary user; and
providing in the first user page region a second indicator, of at least one member of a second group of parameters, the second indicator determined by input by the primary user, and the members of the second group of parameters consisting of: (a) an item the primary user desires to acquire, as specified by the primary user; (b) an item the primary user desires to rent, as specified by the primary user; (b) a specification of potential travel by the primary user; (c) a nonmonetary aspiration of the primary user, as specified by the primary user; and (d) a person and/or a characteristic of a person the primary user desires to meet or engage in a relationship, as specified by the primary user;
wherein the first and second indicators are viewable by the primary user and by the first set of persons.

2. The method of claim 1, wherein the first user page region comprises a web page.

3. The method of claim 1, wherein a web page comprises the first user page region.

4. The method of claim 1, further comprising enabling the primary user to selectably make at least one of the first and second indicators nonviewable by the first set of persons while the least one of the first and second indicators remains viewable by the primary user.

5. The method of claim 1, further comprising providing in the first user page region a third indicator, of at least another member of the first group or another member of the second group of parameters, the third indicator determined by input by the primary user.

6. The method of claim 5, wherein the third indicator is viewable by the primary user and, based on a selection by the primary user, viewable or nonviewable by the first set of persons.

7. The method of claim 1, further comprising:
receiving, by a computer processor and from a client device controlled by the primary user, a search query comprising a plurality of search parameters;
wherein the search parameters are based, at least in part, on at least one of: (i) the at least one member of the first group of parameters, and (ii) the at least one member of the second group of parameters; and
after the receiving, providing, by the processor and to the client device, information associated with the plurality of search parameters.

8. The method of claim 7, further comprising providing at least one of the search parameters in the first user page region such that at the least one of the search parameters is viewable by the primary user and by the first set of persons.

9. The method of claim 7, further comprising providing an indicator of the information in the first user page region.

10. The method of claim 8, further comprising providing an indicator of the information in the first user page region.

11. The method of claim 9, further comprising enabling the primary user to selectably make the indicator nonviewable by the first set of persons while the indicator remains viewable by the primary user.

12. The method of claim 10, further comprising enabling the primary user to selectably make the indicator nonviewable by the first set of persons while the indicator remains viewable by the primary user.

13. The method of claim 7, further comprising:
providing a secondary user page region in the computer system;
providing in the secondary user page region an indicator of an identity of a secondary user that is (i) input by the secondary user, and (ii) viewable by the secondary user and by a second set of persons comprising at least one person other than the secondary user;
wherein the secondary user and the at least one person other than the secondary user are separated from each other at locations on the network; and
providing in the secondary user page region a secondary indicator, determined by input by the secondary user and viewable by the secondary user and by the second set of persons, the secondary indicator indicating at least one of:
(I) a member of an X group of parameters consisting of: (a) a skill of the secondary user, as specified by the secondary user; (b) an item possessed by the secondary user, as specified by the secondary user; (c) an item rented by the secondary user, as specified by the secondary user; (d) a service provided by the secondary user, as specified by the secondary user; (e) a characteristic of the secondary user, as specified by the secondary user; and (f) a person known and/or related to the secondary user, as specified by the secondary user;
(II) a member of a Y group of parameters consisting of: (a) an item the secondary user desires to acquire, as specified by the secondary user; (b) an item the secondary user desires to rent, as specified by the secondary user; (b) a specification of potential travel by the secondary user, as specified by the secondary user; (c) a nonmonetary aspiration of the secondary user, as specified by the secondary user; and (d) a person and/or a characteristic of a person the secondary user desires to meet or engage in a relationship, as specified by the secondary user; and
(III) a member of a Z group of parameters consisting of: (a) a concept the secondary user is considering, as specified by the secondary user; (b) an item and/or person about which the secondary user has learned, as specified by the secondary user; (b) a statement about a past activity and/or future activity of the secondary user and/or another person, as specified by the secondary user; and (c) a commentary and/or critique by the secondary user;
wherein the information associated with the plurality of search parameters is based on an association between the secondary indicator and at least one of (i) the at least one member of the first group of parameters, and (ii) the at least one member of the second group of parameters.

14. The method of claim 13, wherein the secondary indicator indicates the member of the Y group of parameters, and the information associated with the plurality of search parameters is based on an association between the secondary indicator and the at least one member of the first group of parameters.

15. The method of claim 14, further comprising enabling the secondary user to purchase a good or service from the primary user by a transaction conducted over the network, the good or service indicated in the information.

16. The method of claim 13, wherein the secondary indicator indicates the member of the X group of parameters, and the information associated with the plurality of search parameters is based on an association between the secondary indicator and the at least one member of the second group of parameters.

17. The method of claim 16, further comprising enabling the primary user to purchase a good or service from the secondary user by a transaction conducted over the network, the good or service indicated in the information.

18. The method of claim 13, wherein the secondary indicator indicates the member of the Z group of parameters, and the information associated with the plurality of search parameters is based on an association between the secondary indicator and the at least one member of the first group of parameters.

19. The method of claim 18, further comprising enabling the secondary user to purchase a good or service from the primary user by a transaction conducted over the network, the good or service indicated in the information.

20. The method of claim 13, wherein the secondary indicator indicates the member of the Z group of parameters, and the information associated with the plurality of search parameters is based on an association between the secondary indicator and the at least one member of the second group of parameters.
